(19) United States
(12) Patent Application Publication
(10) Pub. No.: US 2019/0089760 A1
(43) Pub. Date: Mar. 21, 2019

(54) SYSTEMS AND METHODS FOR REAL-TIME CONTENT CREATION AND SHARING IN A DECENTRALIZED NETWORK

(71) Applicants: Junshan Zhang, Tempe, AZ (US); Duo Lu, Tempe, AZ (US); Anirban Bhattacharya, Tempe, AZ (US)

(72) Inventors: Junshan Zhang, Tempe, AZ (US); Duo Lu, Tempe, AZ (US); Anirban Bhattacharya, Tempe, AZ (US)

(21) Appl. No.: 16/137,282

(22) Filed: Sep. 20, 2018

Related U.S. Application Data
(60) Provisional application No. 62/561,069, filed on Sep. 20, 2017.

(51) Int. Cl. H04L 29/06; H04L 29/08

(52) U.S. Cl. CPC H04L 65/607; H04L 65/1069; H04L 67/104; H04L 65/4092; H04L 65/80; H04L 65/608

(57) ABSTRACT

Various embodiments of a system and related methods for real-time screen recording/sharing and content sharing between a host device and a plurality of client devices in a decentralized network are disclosed.

### CROSS REFERENCE TO RELATED APPLICATIONS

This is a non-provisional application that claims benefit to U.S. provisional application Ser. No. 62/561,069 filed on Sep. 20, 2017 which is incorporated by reference in its entirety.

### GOVERNMENTAL RIGHT

This invention was made with government support under ECCS-1408409 awarded by National Science Foundation. The government has certain rights in the invention.

### FIELD

The present disclosure generally relates to real-time screen recording and content sharing; and in particular relates to a system architecture for configuring devices to form a decentralized, device-to-device (D2D), edge, and/or “Fog” network and further configuring the devices to provide real-time screen and content sharing functionality over the network via an improved streaming protocol which provides high throughput and reduced latency, despite the technical challenges associated with real-time content sharing across decentralized networks.

### BACKGROUND

Content sharing between devices is desirable in a number of different scenarios and each scenario may present its own unique challenges. For example, it may be desirable to share content between mobile devices associated with workers at a mining site or on a cruise ship; yet, physical obstructions or proximity to radio towers may result in general bandwidth restrictions which may limit functionality and streaming quality. Further, the type of content being shared can affect performance and implementation requirements. For example, a screen of a desktop computer to be shared may reflect general movement patterns of sliding, page up, and page down and may define content that does not change significantly most of the time, whereas a screen of a third party application such as game may define content that changes substantially over a short period of time.

Most conventional mobile platforms for content creation and sharing are cloud-based. Notwithstanding the tremendous success of the cloud-based solution, a consensus is that there are some open issues associated with cloud-based services, including unpredictable latency and jitter, privacy/security concerns, demand on network bandwidth and storage.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is a simplified block network diagram of a decentralized D2D Fog network generated by and between two or more devices for media content sharing as described herein;

FIG. 1B is a simplified network diagram of one embodiment of the network of FIG. 1A where at least one of the devices of the network is configured for real time streaming of media content to other devices;

FIG. 1C is a simplified network diagram of another embodiment of the network of FIG. 1A where at least one of the devices of the network is configured for real time streaming of media content to other devices and a broker device is implemented as described herein;

FIG. 2 is a simplified block diagram illustrating one possible process flow for creating a D2D fog network, generating media content, and implementing real-time sharing of the media content as described herein;

FIGS. 3A-3C are images of network diagrams illustrating possible configurations of a network for connecting and sharing content between devices;

FIG. 4 is a set of images illustrating in-app recording and full-screen recording of media content such as images;

FIG. 5 is a simplified block diagram illustrating encoding of image frames for sharing with other devices;

FIG. 6 is a simplified block diagram illustrating session creation for sharing media content between devices;

FIGS. 7A-7C are simplified block diagrams illustrating transmission of encoded frames from a streaming device to other devices;

FIGS. 8A-8C are simplified block diagrams illustrating transmission of encoded frames from a streaming device to other devices using different configurations of a decentralized network;

FIG. 9 is a simplified block diagram of possible streaming structure associated with a streamer or streaming device;

FIG. 10 is a simplified block diagram of possible streaming structure associated with a watcher or receiving device;

FIG. 11 is a diagram illustrating a possible procedure for streaming and messages;

FIG. 12 is a diagram illustrating a RTScreen data plane timing model;

FIG. 13 is an image illustrating a packet of a screen frame;

FIG. 14 is an image illustrating feedback of an individual packet of a screen frame;

FIG. 15 is an image illustrating feedback of a whole screen frame;

FIG. 16 is an image illustrating feedforward of a whole stream session (periodical);

FIG. 17 is an image illustrating feedforward of a whole stream session (emergent);

FIG. 18 is an image illustrating screen blocks used in screen content variation detection;

FIG. 19 is a graph illustrating receiving timestamps of each packet in a frame (relative to the first packet).

FIG. 20 is an image illustrating frame timing;

FIG. 21 is a pair of graphs illustrating examples of delay on the streamer side and the watcher side;

FIG. 22 is a pair of graphs illustrating examples of the frame round trip time and packet round trip time;

FIG. 23 is a simplified block diagram illustrating implementation of traffic shaping and packet scheduling;

FIG. 24 is a simplified block diagram illustrating overrun control;

FIG. 25 is a simplified block diagram illustrating a possible process flow for implementing aspects of the present disclosure; and

FIG. 26 is a simplified block diagram showing an example of a computing system that may implement various services, systems, and methods discussed herein.

Corresponding reference characters indicate corresponding elements among the view of the drawings. The headings used in the figures do not limit the scope of the claims.

### DETAILED DESCRIPTION

The present disclosure is directed to embodiments of a decentralized, D2D, peer-to-peer, and/or fog-based system architecture for connecting and sharing content between devices. In particular, the system architecture may include a service application installed to and executable by two or more devices for forming a decentralized network, such as a D2D, fog network, edge network, or any ad hoc network and connecting the devices via the network. In addition, the service application may define or otherwise be implemented in conjunction with an improved streaming protocol (RTScreen) that configures devices for, via the network, real-time screen recording/sharing, real-time collaborative content creation, and live content sharing via screen broadcast between the devices as described herein. In some embodiments, the subject screen recoding/sharing may be provided directly between the devices of the network. Using the network and service application as described, the devices do not require connection to the Internet or an intermediate device such as a managing server, administrator, or network device. Collectively, the various components of the system architecture provide screen-sharing and/or streaming of content from one streaming device to another or many other receiving devices, as described herein. Advantageously, it should be understood that each device of the network described herein, configured with the service application, may function both as a streaming device and/or also as a receiving device.

The present system architecture, including the improved streaming protocol dubbed RTScreen described herein, is configured to address specific technical challenges associated with media content sharing in the context of D2D or peer-to-peer networking and computing. First, full screen recording is largely somewhat undeveloped with respect to conventional mobile device operating systems. For example, full screen recording was disallowed on iOS devices until at least the summer of 2017. Second, real-time screen sharing has its unique characteristics. For example, a computer screen includes movement patterns associated with sliding, navigating a page up, and/or navigating a page down where the content does not change significantly most of the time; whereas sharing screen in third party applications such as games leads to drastic content changes of the screen content. Further, real-time streaming of a high resolution screen directly between devices makes it more difficult to carry out buffering and adaptive usage of bandwidth, which is fundamentally different from on-demand video streaming over the Internet where more aggressive buffering can be employed. The situation gets even more complicated in a system that allows anyone with an App to be a streamer or a watcher, and where multiple streaming sessions are competing for limited local WiFi bandwidth in the same network.

Responsive to the aforementioned technical challenges, a variety of technical solutions are described herein as part of the disclosed system architecture, associated with RTScreen or otherwise. In particular for example, RTScreen includes screen content streaming and screen content management protocol features for implementing close-loop (both feedback and feedforward) control between a streaming device and a receiving device (or devices) to enable real-time adaptation, thereby significantly enhancing real-time streaming performance. RTScreen further includes features for adaptively updating a streaming rate based on changes to screen content; features for unified dynamic packetization, active frame duplication, and selective packet transmission to increase the likelihood of packet delivery (associated with media content) even under congested network conditions; automatic screen-to-screen delay for dynamically adjusting a receiving device buffer based on network quality; smart stream congestion detection; features for traffic shaping and packet scheduling to improve streaming performance with multiple different streaming devices; and overrun control for managing temporary reductions in processing resources; such protocol features collectively designed to address unique challenges with content sharing over a D2D network, as further described herein.

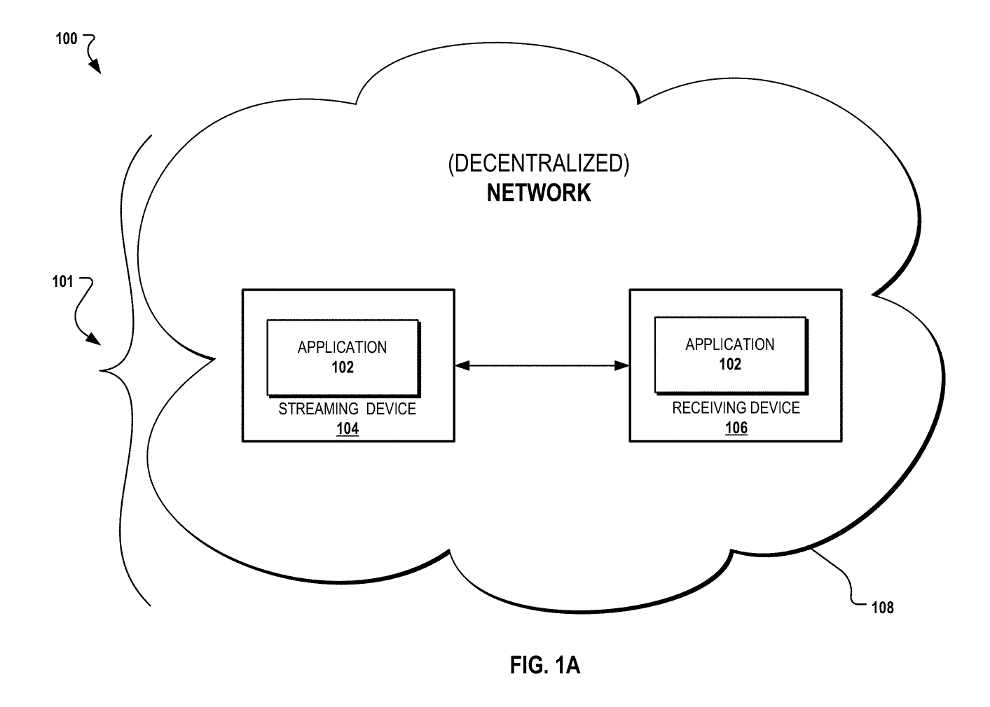

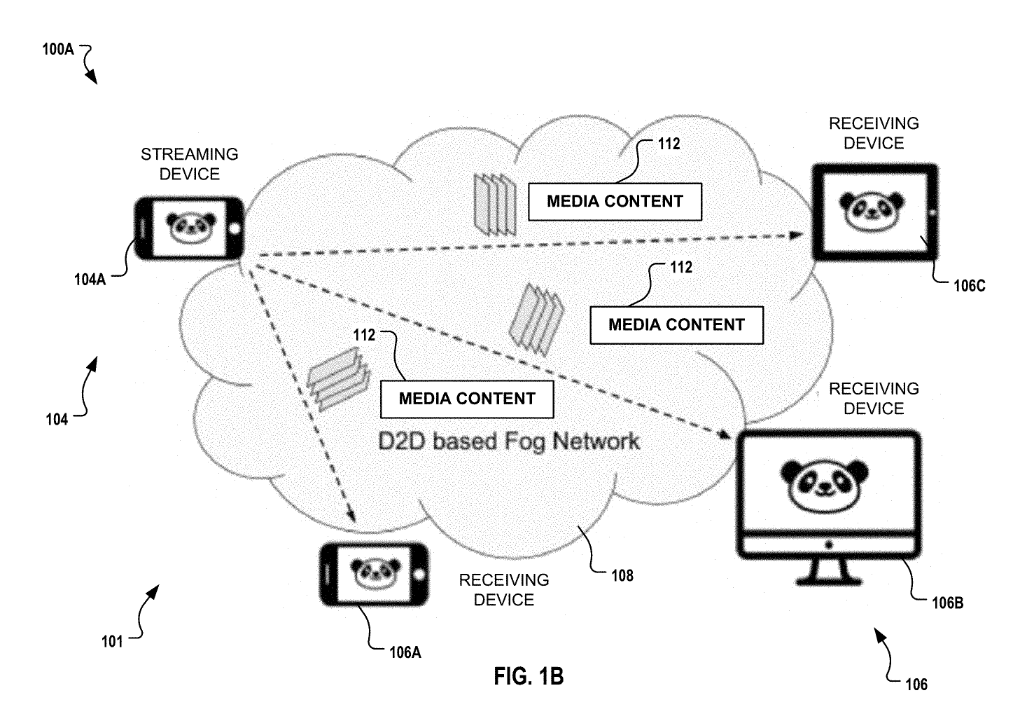

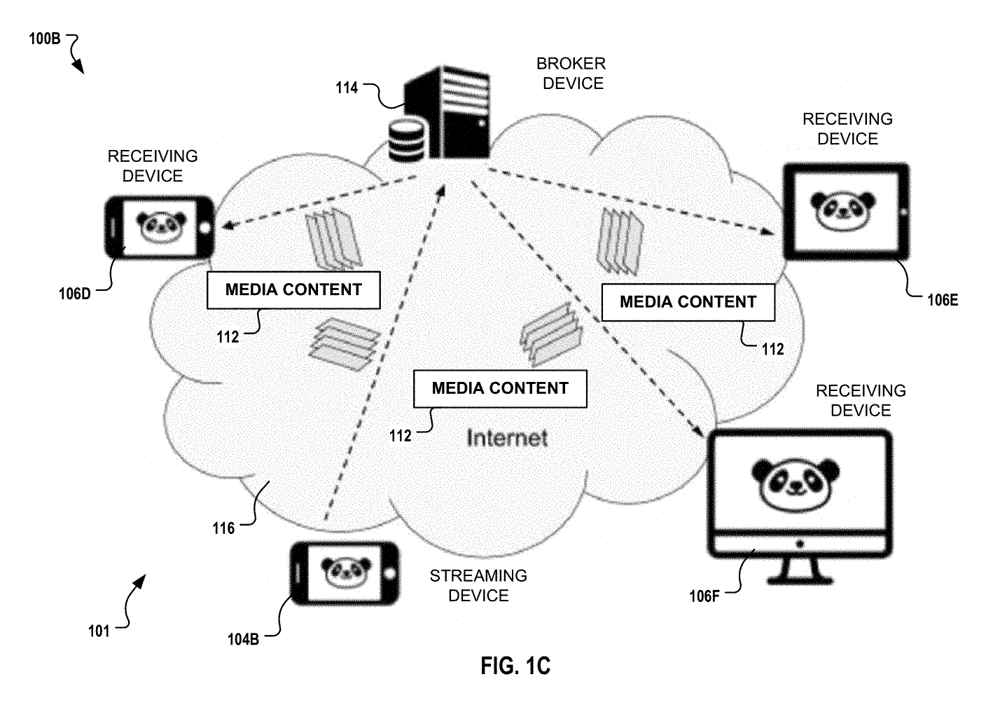

Numerous use cases or possible applications of the present novel concept are contemplated. For example, when delivering a digital presentation via a presenter device, a presenter may open a set of presentation slides within the described service application (executed by the presenter device), or while the application is running in the background. Other users associated with devices connected to the presenter device may then “connect” to the speaker's application using an authentication token generated by the speaker's application. The screen of the presenter's application may then be shared, via live screen recording and streaming technology described herein, with the connected devices in a real time manner. In this way the users may be able to view whatever the host (the presenter in this example) is viewing on the host device. As another example, a user may share multimedia content (e.g., music or video) with other users connected within the same network in real time. Embodiments of the system architecture for forming a network for real-time media content sharing between devices of the network are generally described as 100 or 100A in FIGS. 1-26.

Referring to FIG. 1A, an exemplary system architecture (hereinafter “system”) 100 is illustrated for configuring one or more devices 101 to implement functionality associated with decentralized D2D/fog/edge-based media content sharing. The system 100 may include and/or generally support functionality defined by a service application (hereinafter “application”) 102 installed to the devices 101. In the example shown, the devices 101 include a streaming device 104 and a receiving device 106. When installed by one or more of the devices 101, the application 102 may configure the devices 101 to form a D2D fog network and further configure the devices to provide real-time media content sharing functionality as described herein. As indicated for example, the streaming device 104 and the receiving device 106, having installed and executing instances of the application 102, are configured to form a network 108, and the application 102 further configures the devices such that the streaming device 104 may share media content with the receiving device 106 via the network 108, as further described herein.

Advantageously, it should be understood that the devices 101, configured with the application 102, may also function both as streaming and/or receiving devices, such that the receiving device 106 may also be configured to share with and stream content to the streaming device 104. In addition, FIG. 1A merely illustrates a broad and simple example of the present inventive concept involving two of the devices 101; yet, the media content sharing functionality described herein may apply to three or more of the devices 101 as desired and as permitted by bandwidth and network conditions. In addition, in some embodiments, multiple ones of the devices 101 may be sharing media with other devices, and/or multiple sharing/streaming sessions may be implemented between the devices 101. Any of the devices 101, including the streaming device 104 and receiving device 106 may define, without limitation, one or more of a mobile device, a tablet, a smartphone, a console, a laptop, a desktop computer, a workstation, a server, a terminal, a controller, or any such computing device having a processor or processing element configured to execute the application 102.

The network 108 as illustrated may include any decentralized network such as a D2D network, a fog-based network, peer-to-peer network, an edge network, D2D or peer-to-peer content delivery network (CDN), or any form of ad hoc network such that the network 108 provides a decentralized logical infrastructure for media sharing between the devices 101. In some embodiments, the network 108 is devoid of a central, core, or intermediate entity such as a base station, router, intermediate resource management, or other intermediate network element such that e.g., the streaming device 104 establishes a direct connection with the receiving device 106, and vice versa and the devices are in direct communication with one another, via in-band or out-band frequencies and/or direct connections (examples of which are described herein). In this manner, in some embodiments, the network 108 leverages the close physical proximity of the devices 101 to one another while also leveraging the various networking advantages of direct communication between the devices 101 for media content sharing or otherwise, as described herein.

In some embodiments, the network 108 includes a fog network; which refers to extending computing to an edge of a network, also known as edge computing, or fogging. In other words, fog networking facilitates the operation of compute, storage, and networking services between end devices. With a fog network, by interconnecting devices (directly or otherwise) at the network edge, data may be processed more efficiently rather than having to transmit data to a cloud or intermediate device for processing.

In some embodiments, the network 108 may further define a peer-to-peer overly network or ad hoc network. A peer-to-peer overly network relates to a network in which member nodes obtain services in the absence of server-based infrastructure. In a peer-to-peer overlay, peer nodes co-operate with each other both to provide services and to maintain the network. Peer-to-peer overlay networks can be built on top of an underlying network that provides host to host connectivity, such as a network utilizing an Internet Protocol (IP). Examples of an overlay network include, but are not limited to, the Internet (e.g., overlay on a telephone network), Chord, Content Addressable Network (CAN), Pastry, and Viceroy. In general, nodes in an overlay may not all be able to communicate with each other pairwise. However, they may all communicate with one another via the overlay through multi-hop underlay routes. An ad hoc network is a temporary, self-organizing, type of device-to-device or temporary computer-to-computer network connection (generally wireless), for establishing a connection between devices without having to connect to an access point, router, or other such network device. An ad hoc network operates without any need for infrastructure such as a central entity including a base station or networking device, may utilize mufti-hop radio relay concepts, and hence be considered a multi-hopped network.

The network 108 may also include a software-defined network. In a software defined network, a network can be managed and modified without the need to interact with physical switches or other network devices. A software-defined controller or other software element, directs the delivery of network services as desired, regardless of the specific connections between the devices. The controller (or control layer) further manages the policies and flow of traffic through a network. Where a traditional network would involve a specialized appliance or network device, a software-defined network replaces such an appliance with an application that uses the controller to manage data plane behavior and other network functions.

In some embodiments, the network 108 may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT network relates to the ability to connect more than just computers and communications devices, but rather the ability to connect “objects” in general, such as lights, appliances, vehicles, heating, ventilating, and air-conditioning (HVAC), windows and window shades and blinds, doors, locks, displays, etc. The “Internet of Things” thus generally refers to the interconnection of objects (e.g., smart objects), such as sensors and actuators, over a computer network (e.g., via IP), which may be the public Internet or a private network. In these embodiments, as a simple non-limiting example, the receiving device 106 may include a display of a refrigerator or other smart device of an IoT network.

In some embodiments, the network 108 may include a general CON, private CON, or peer-to-peer CON. As such, the streaming device 104 may be considered an original content distributor of the network 108 or point of presence (POP), and may share media content with the receiving devices 106. In this embodiment, a variety of unicasting and/or multicasting techniques may be implemented to optimize bandwidth consumption.

In any event, the network 108 is configured to be decentralized in the manner described by any of the embodiments described herein in order to improve upon and address the limitations of e.g., general Transmission Control Protocol (TCP) which may result in packet loss and may be prone to errors due to network congestion. The system 100 is uniquely designed to optimize and improve media content sharing in the context of any of the decentralized networks described herein.

Different embodiments of the system 100 are contemplated. For example, referring to FIG. 1B, one embodiment of the system 100, designated system 100A, is shown. In this example, the system 100A includes devices 101 defining a streaming device 104A, a receiving device 106A, a receiving device 106B, and a receiving device 106C. The network 108 is formed between these devices to accommodate the screen/audio recording and sharing of media content 112 between the streaming device 104A and the receiving device 106A, receiving device 106B, and receiving device 106C as shown. Another embodiment of the system 100, illustrated as system 100B, is shown in FIG. 1C. As indicated, a broker device 114 of the devices 101 may be implemented to facilitate communications and the sharing of media content 112 between a streaming device 104B, and receiving devices 106D-106F of the devices 101, using a network 116. In this embodiment, the network 116 involves use of the Internet as shown.

Each of the streaming device 104A/104B, the receiving devices 106A-106F, or broker device 114 may include a name or identifier, typically the same as the hostname or an arbitrary name set by the device owner. The streaming devices 104A-104B may access or grab the media content 112 in the form of screen content frames (sometimes referred to herein as “frames”), may record audio using speakers, microphones, or other audio components of the streaming devices 104A-104B, and transmit this media content 112 to the receiving devices 106A-106F and optionally the broker device 114. In turn, the receiving devices 106A-106F receive screen frames and audio segments from the streaming device 104A/104B or a broker and display them. The broker device 114 may include an intermediate server that receives screen frames from a streaming device 104 and forwards them to one or more receiving devices 106. From the streamer side, the broker device 114 is the same as a receiving device 106 (while the connection initiation is in the reverse direction), and from the receiving device 106 side, the broker device 114 is the same as the streaming device 104. In some embodiments, the broker device 114 is a server with a public IP address accessible via the Internet that allows devices 101 behind firewalls to share screens over the Internet.

This present disclosure is directed mainly to the local D2D based fog network streaming of a screen and/or audio file without the broker device 114 for simplicity. In addition, audio streaming is similar to screen frame streaming such that the present disclosure mainly focuses on the streaming of a screen or video file from one device to another. In some embodiments, the traffic pattern mainly defines or relates to a publish-subscribe model (with feedback from the receiving device 106 to the streaming device 104, and/or vice versa), and the present disclosure describes the additional components of the system 100 with the assumption that only a sole streaming device 104 is implemented, although the present disclosure is not limited in this regard.

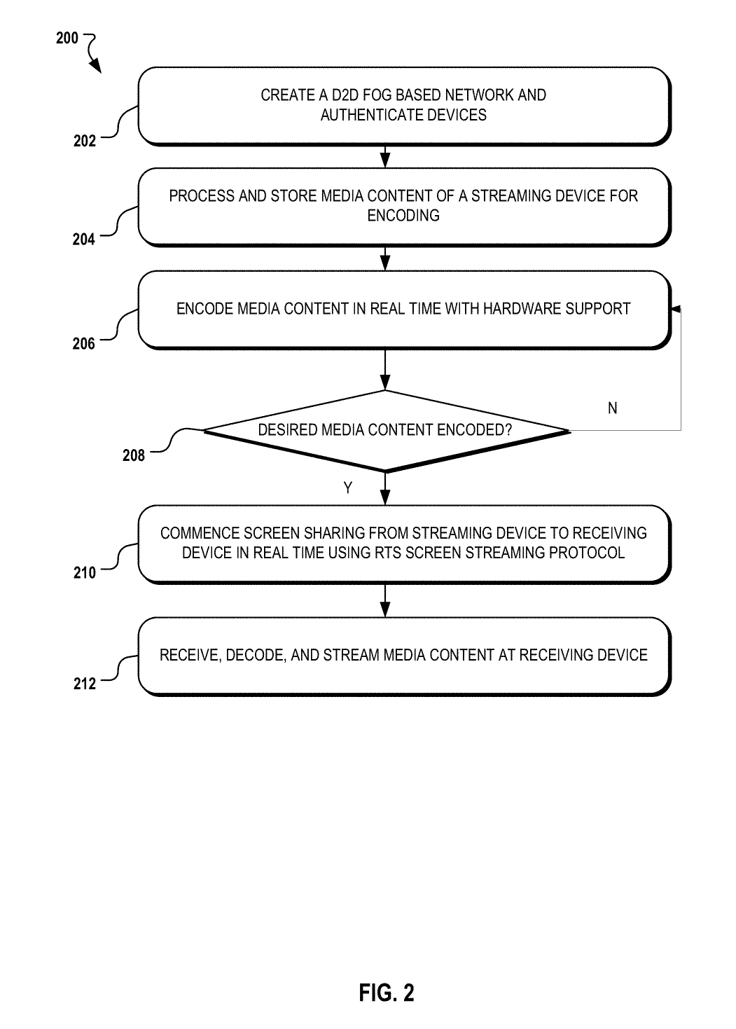

Referring to the process flow 200 of FIG. 2, one method for real-time screen/audio recording and sharing is illustrated using the system 100 or system 100A. As shown, the process flow 200 may generally include the steps of creating the network 108 in block 202, processing and capturing media content in block 204, encoding the media content in block 206, determining whether additional content is to be encoded and shared in decision block 208, streaming media content to screen and/or share audio content in block 210, and receiving, decoding, and streaming media content in block 212; however, additional variations of the process flow 200 are contemplated. The steps of process flow 200 are described with general reference back to FIG. 1A and FIG. 1B for an implementation of a system 100 or system 100A that does not require and in some embodiments is devoid of a broker device 114 or other intermediary device or network element. The application 102 may be installed to the devices 101 prior to the formation of the network 108 to configure the devices 101 for formation of the network 108 and/or media content sharing, but the present disclosure is not limited in this regard.

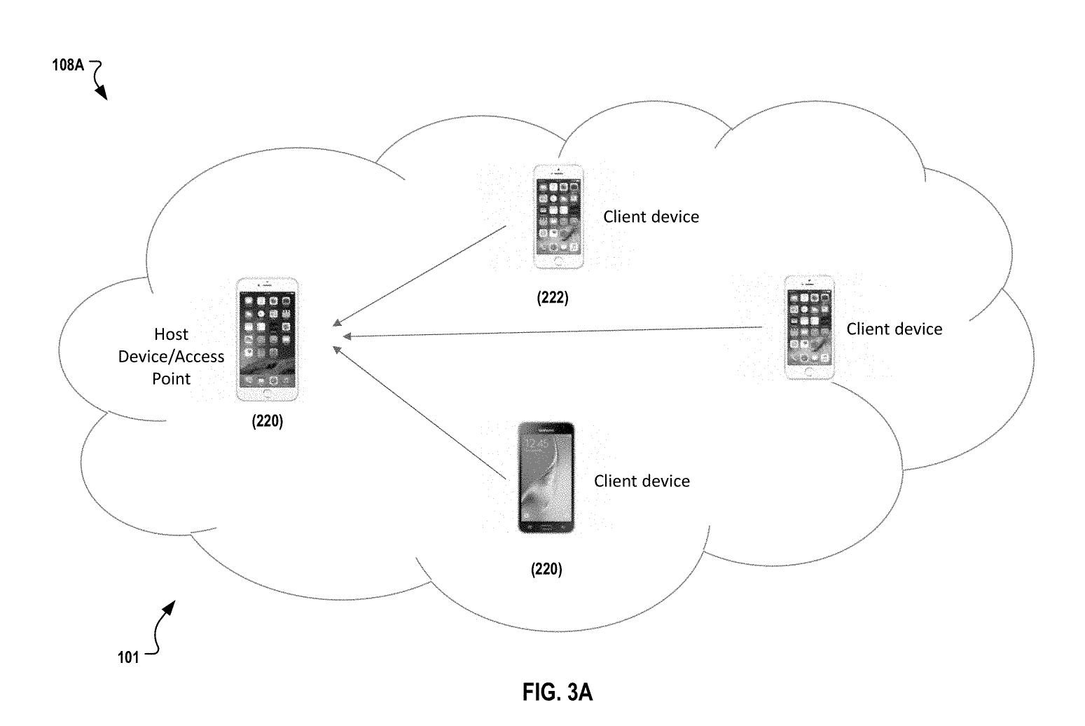

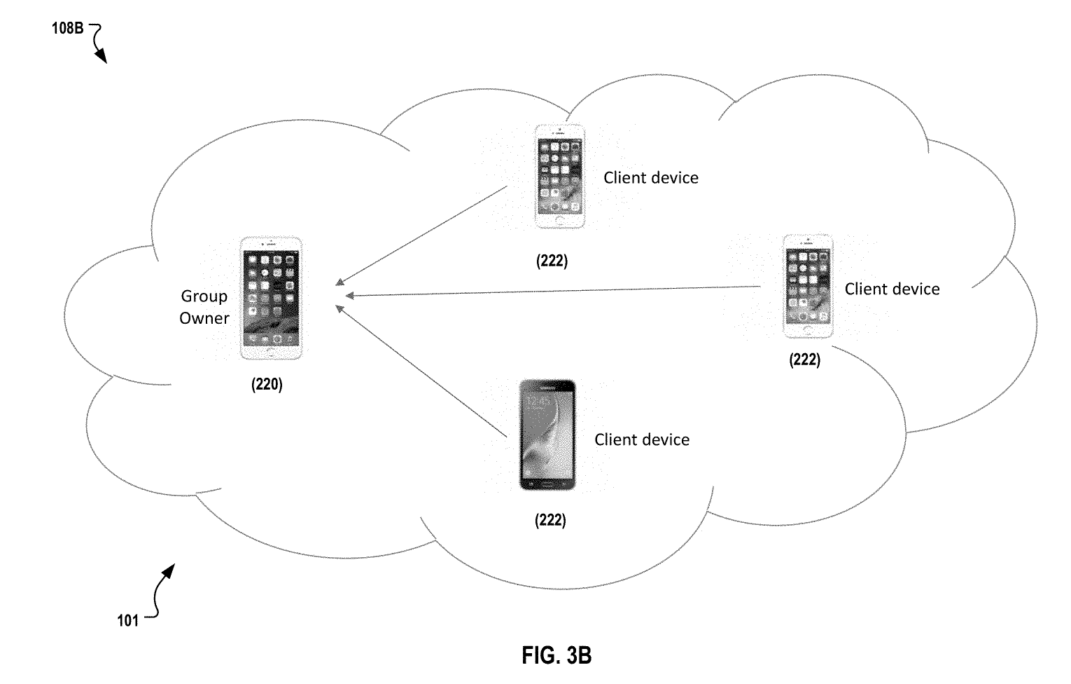

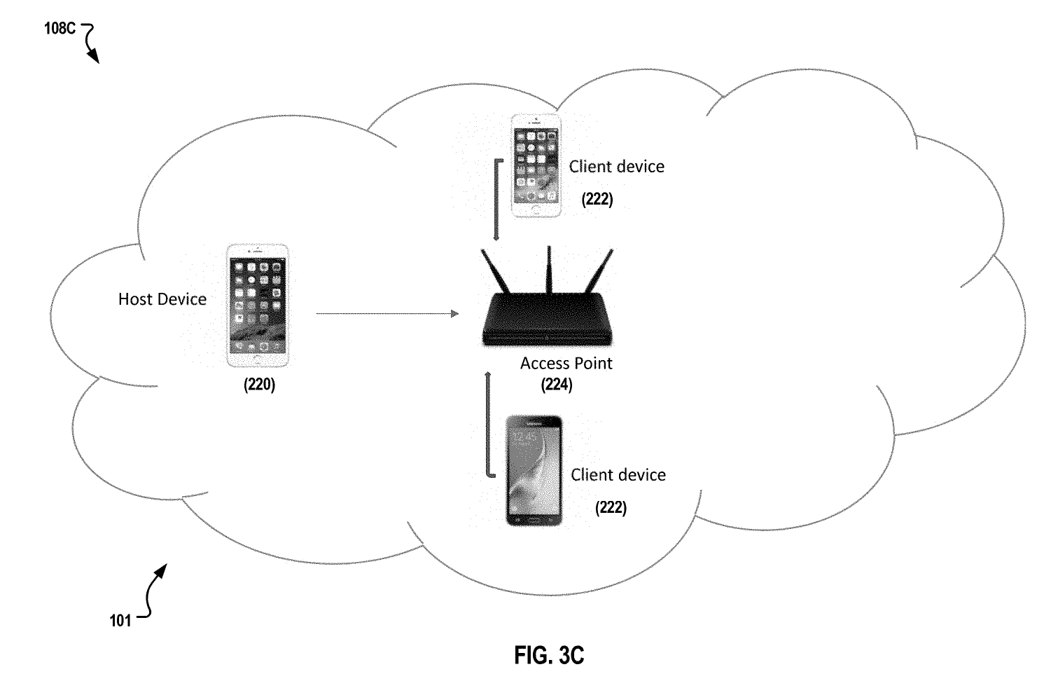

At block 202, a host device of the devices 101 (shown as 220 in FIGS. 3A-3C), which may be the streaming device 104A but is not limited to the same, forms the network 108 to enable the application 102 executed by the devices 101 to work across different operating systems (iOS or Android), such as for laptops, smartphones, and tablets of the devices 101. The network 108 may take the form of many different possible configurations of decentralized networks. For example, referring to FIG. 3A, a host device 220 of the devices 101 may create a network 108A defining an ad-hoc personal hotspot—a feature available on many mobile devices—which may also generally define a fog network, and may be referred to herein as a “Personal Hotspot Model.” In the instant Personal Hotspot Model, the host device 220 functions as an access point and coordinates network formation. All other devices (e.g., client devices 222 of the devices 101) establish a regular WiFi connection to the access point (host device 220) as if it were external to the network 108A.

Referring to FIG. 3B, the network 108 formed between the devices 101 may also include a WiFi Direct network 108B, allowing for quick network creation and one-hop WiFi transmission speeds, and generally referred to herein as a “WiFi Direct Model.” In the WiFi Direct Model, the host device 220 acts as group owner and coordinates network formation. All other ones of the devices 101 (e.g., client devices 222) establish a D2D connection to the group owner/host device 220.

Referring to FIG. 3C, the network 108 formed between the devices 101 may also include a network 108C defining a “Local Network Model,” where the host device 220 may use an existing local-area access point (AP) to arbitrate the network 108C and handle transfer of content between the devices 101. In the Local Network Model, the host device 220 and all the client devices 222 connect to a common access point 224 for network formation. In some embodiments, the first two network options still permit the devices 101 to access digital content stored in a cloud via a mobile network connection, and the third option provides the same functionality, assuming that the access point 224 has a connection to the Internet. These options/models are merely exemplary, as the decentralized network 108 may take other additional forms as described herein.

Further in block 202, an authentication process may be initiated in which the host device 220 generates a password for authenticating a particular one of the client devices 222 to the host device 220. Once this authentication is completed, the network 108 is generally configured for accommodating the real time screen recording and content sharing functionality described herein. In addition, upon being authenticated, future sharing sessions may no longer require authentication from client devices 222 that have previously been authenticated or have otherwise previously provided approval for forming the network 108 with the host device 220.

Referring to block 204, media content, in the form of a document or content presented in another application, including text content, audio, image/audio objects, or other media content associated with e.g., the streaming device 104A of the network 108, may be accessed and may be recorded or otherwise temporarily stored. In some embodiments, the application screen of the streaming device 104A is captured and recorded, in a continuous manner, using screen recording application programming interfaces (APIs) associated with, e.g., Android and iOS. Recording the media content in this manner may initially include capturing screen updates.

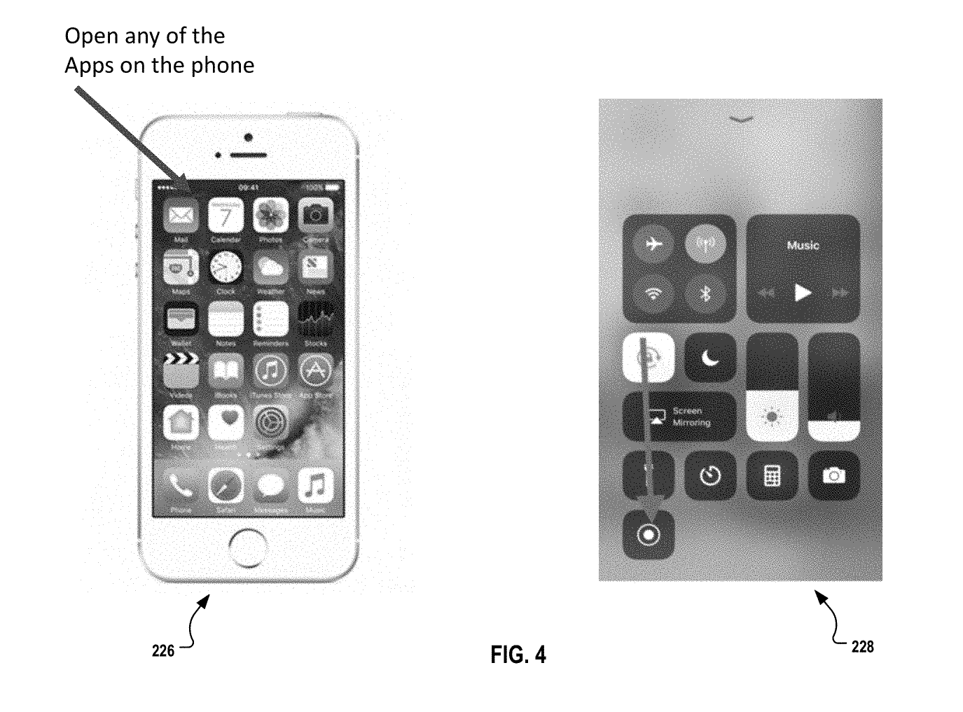

More specifically, in some embodiments, recording of the screen of the streaming device 104A may include two different approaches: (i) in-app screen recording 226; and/or (ii) full screen recording 228, as depicted in FIG. 4. The in-app screen recording 226 uses built-in APIs provided by Android and iOS, such that screen sharing may be executed via the application 102 (which may leverage such built-in operating system APIs). To make screen sharing seamless, frames recorded should be encoded by an encoder in real time. But, the processing rate of the encoder can be lower than the capturing rate of the API utilized. As further described herein, the present inventive concept contemplates lowering down the captured frame rate to match the encoder. This results in real time encoding without any pending frames stacking up. As one example shown in FIG. 4, the in-app recording 226 may involve a user launching a user interface of the application 102, selecting a file or video, and toggling a record button or other input function to initiate screen sharing, such that in-app screen sharing is enabled via the application 102.

Conversely, the full screen recording 228 functions differently, as elaborated further below. Since, there is no in-app recording in this case, a background service may be used to record the full screen of the streaming device 104A. In other words, in this example, the application 102, or at least aspects of the application 102, may take the form of a background service. This background service can only be enabled by the user, so, it is generally considered to be secured because without user intervention, this service cannot be enabled to commence screen recording. As some examples, full screen broadcast may be enabled from an iOS control center; i.e., on iOS devices, this service may be available natively in the operating system itself. There are few technical challenges in sharing the screen using this approach. (A) The background service has limited resources in terms of CPU and memory, and processing and transmitting large-size frames is difficult with such limited resources. To resolve this issue, hardware enabled encoding may be used, because it is fast and uses very less resources. (B) The second challenge is to run a video streaming server within the background service to support live streaming in a fog or general decentralized network. Addressing these challenges is described in greater detail below.

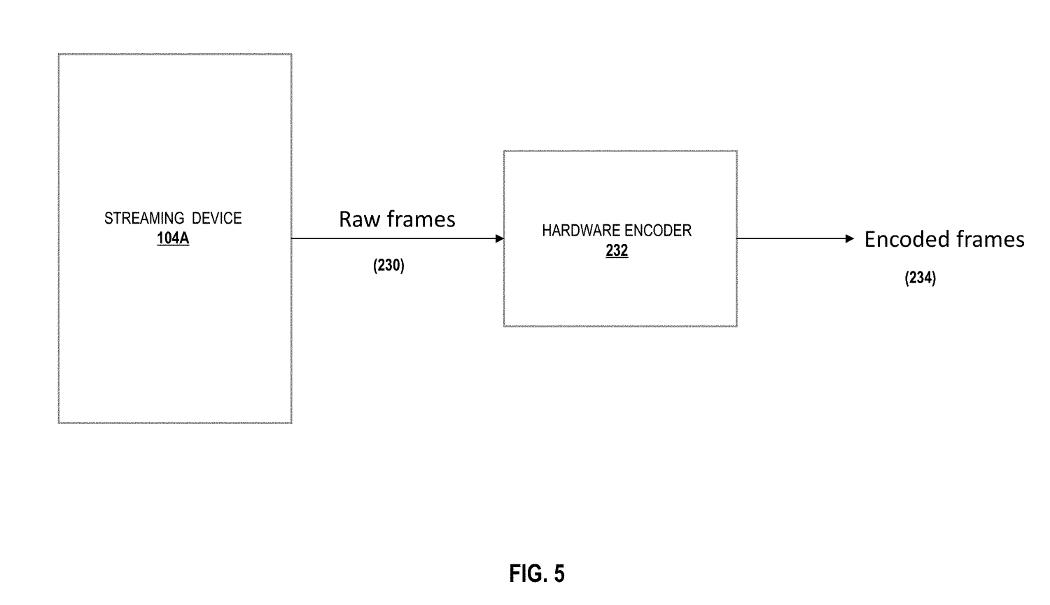

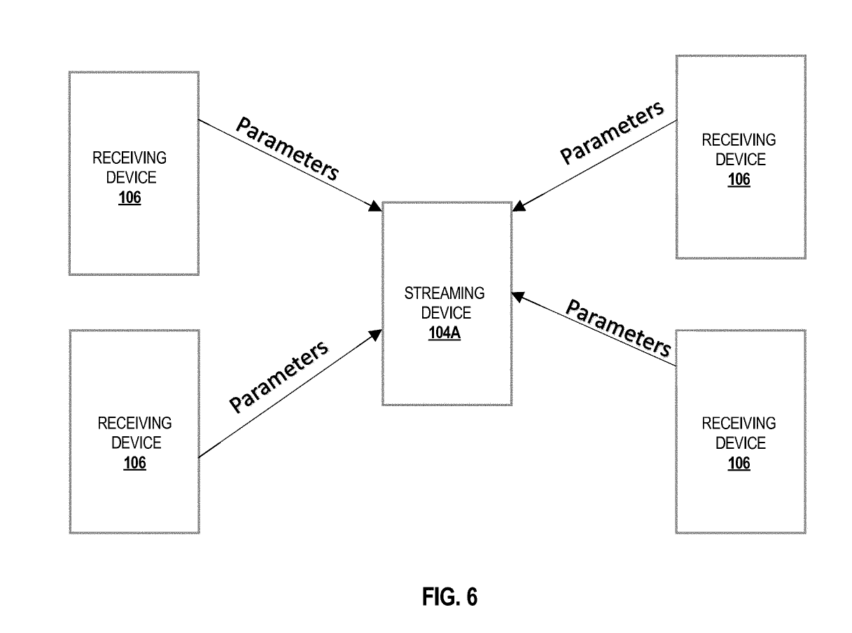

At block 206, the media content recorded by the streaming device 104A may be encoded for transmission to other devices 101. Referring to FIG. 5, in some embodiments, media content recorded in the form of raw frames 230 may be processed and stored for encoding in real time by applying the raw frames 230 to a hardware encoder 232. The present inventive concept considers the possibility that the raw frames 230 accessed from the streaming device 104A may be unsuitable for transmission directly over a network because of their size. Accordingly, the raw frames 230 are stored for encoding, using a hardware encoder 232 suited for real time encoding, preferably with hardware support to reduce latency. The hardware encoder 232 generates encoded frames 234 from the raw frames 230, as further described herein. In some embodiments, a presentation time session may define a set of session parameters including parameters associated with screen resolution, target frame rate, and encoder and decoder parameters. As indicated in FIG. 6 for example, at least some of the sessions parameters may be sent to the streaming device 104A from the receiving devices 106, and these parameters may include parameters for frame rate and bit rate supported by each of the receiving device 106.

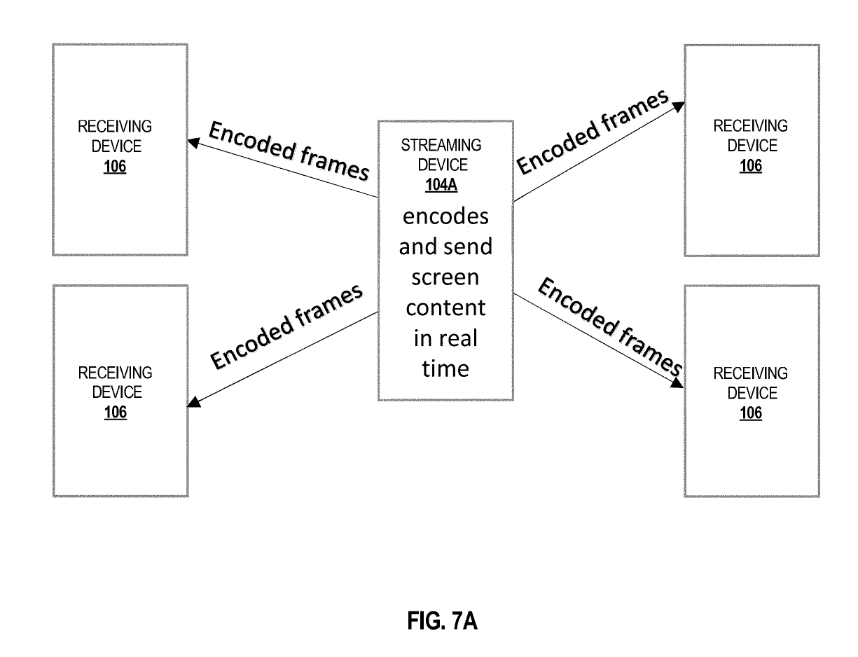

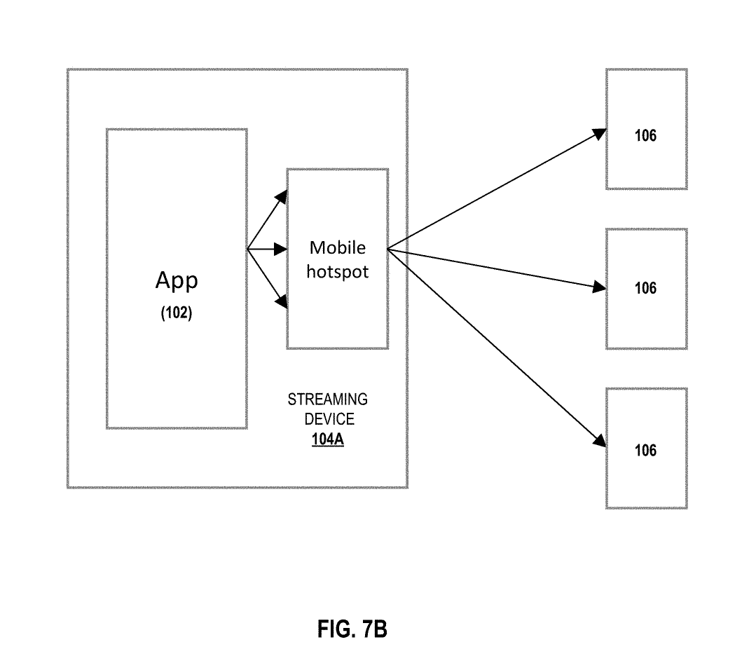

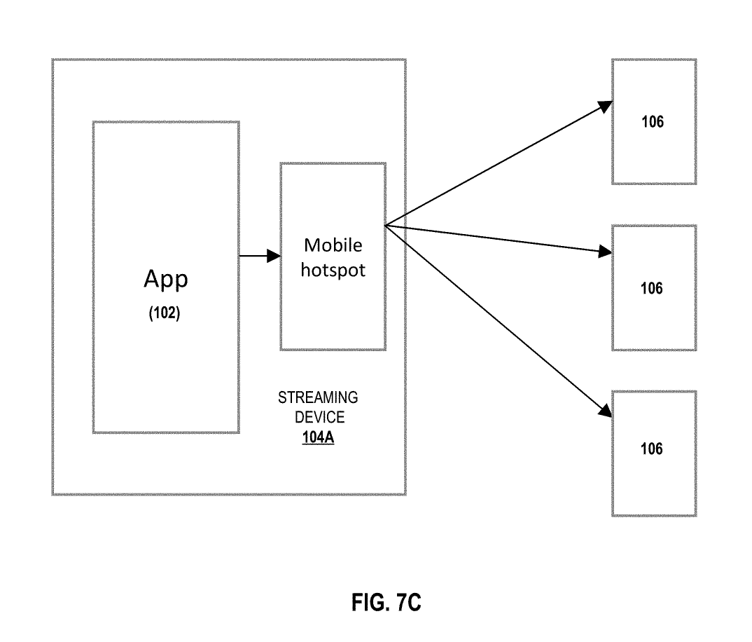

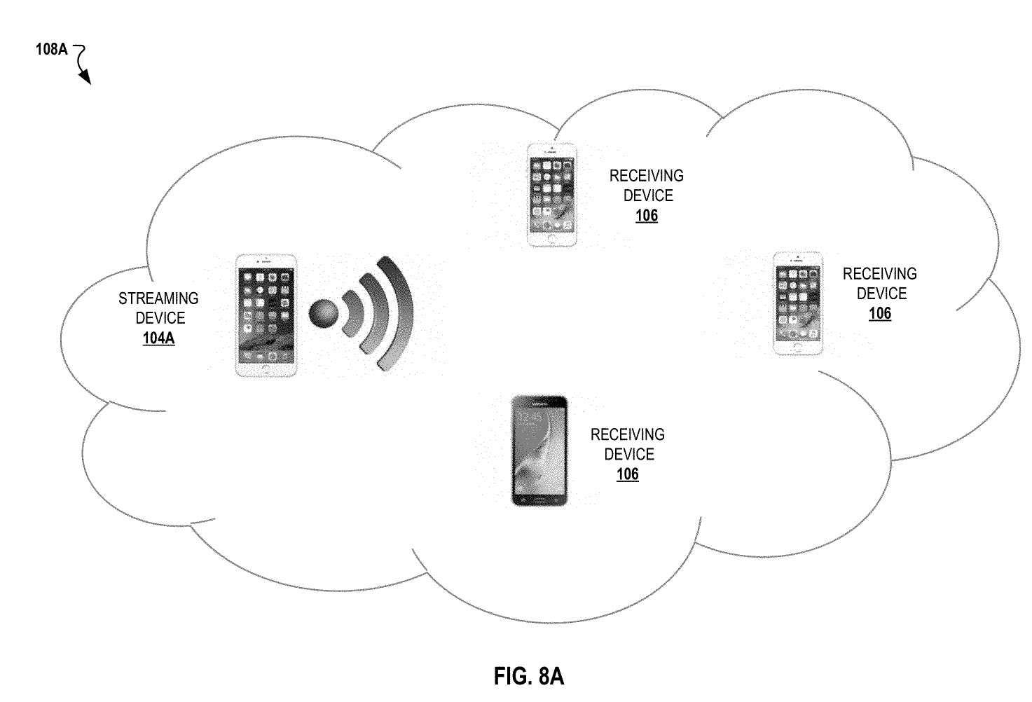

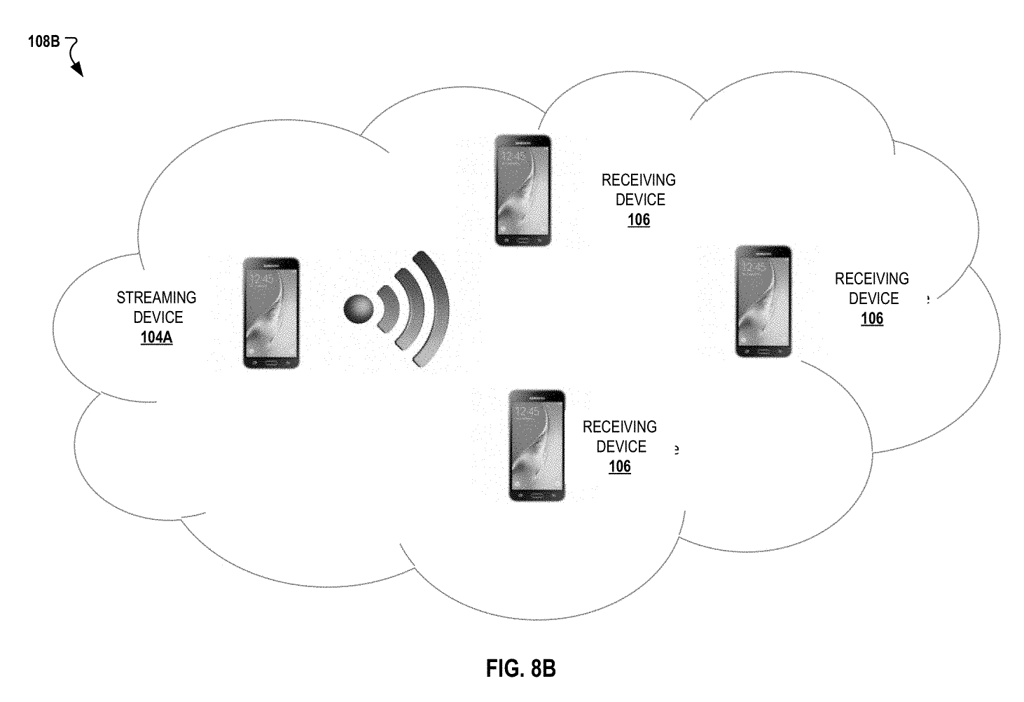

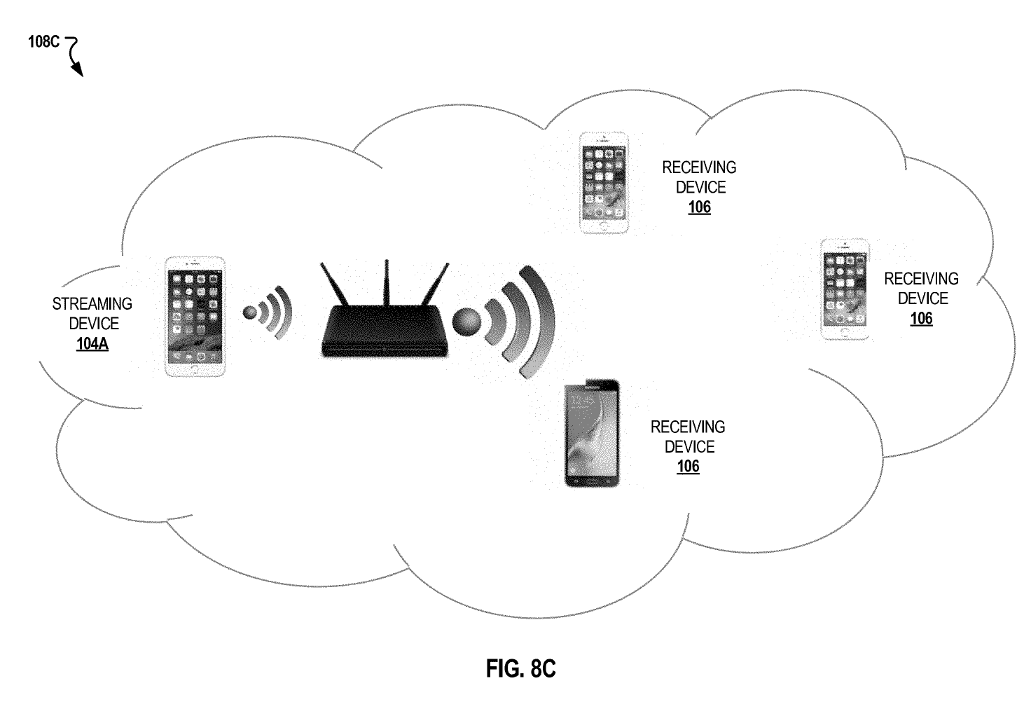

Referring to FIG. 7A, the encoded frames 234 may then be converted to an elementary stream and then transmitted over the network 108 from the streaming device 104A to the receiving devices 106 via a screen broadcast. In some embodiments, the encoded frames (or encoded audio) may be transmitted to the receiving devices 106 in real time using User Datagram Protocol (UDP). Different non-limiting approaches for UDP transmission are contemplated. In one embodiment, the UDP transmission incudes multiple UDP unicast (FIG. 7B). In another embodiment, the UDP transmission includes UDP multicast (FIG. 7C). FIGS. 8A-8C illustrate transmission of the encoded frames 234 or other media content using different configurations of the network 108. FIG. 8A illustrates transmission using the network 108A incorporating the Personal Hotspot Model, where the receiving devices 106 connect to the hotspot of the streaming device 104A (or other host device) and receive the transmission via the network 108A. FIG. 8B illustrates transmission using the network 108B incorporating the WiFi Direct Model, where the streaming device 104A and the receiving devices 106 establish a D2D network and data is broadcasted by the streaming device 104A. FIG. 8C illustrates transmission using the network 108C incorporating the Local Network Model, where all of the devices 101 including the streaming device 104A and the receiving devices 106 connect to the same local access point 224. The streaming device 104A sends data via this access point 224 to all receiving devices 106. The Local Network Model simulates a fog/edge network within the existing local network 108C.

Upon receiving the encoded frames 234, real time sharing of the aforementioned media content between the streaming device 104A and one or more of the receiving devices 106 continues as the receiving devices 106 decode the encoded frames 234 and display the data using the presentation timestamp provided by the streaming device 104A.

Returning to the steps of FIG. 2 associated with recording encoding, and streaming of media content such as image frames, there are various options for addressing the unique challenges of media sharing and streaming in this decentralized network context. As previously indicated, in some embodiments, the system 100A includes implementation of UDP which may include utilization of the existing Real-Time Transport (RTP) protocol. Alternatively, the system 100A may include implementation of an entirely new protocol (RTScreen) described herein.

### RTP Protocol

The implementation of streaming may include generating the encoded frames 234 in order to send them over UDP using either multicast or multiple unicast as described. One main challenge that arises with implementation of RTP in this context is the potential for data loss or corrupted data during transmission, which may lead to corrupted video on the receiving end. To resolve these issues, larger frames need to be further fragmented to smaller packets and multiple tiny frames need to be combined into one single packet. In some embodiments, an existing implementation of RTP according may be sufficient for streaming. The benefit of using RTP is that it comes in handy with the Real Time Streaming Protocol (RTSP) which can fulfill all the session creation requirements and adjusting an encoder according to the other receiving devices in the network. However, the existing RTP implementation can have noticeable latency and is resource intensive so it may not work well with a background service, as in the case where the streaming device 104A is configured for full-screen recording 228.

### RTScreen

Stream Session, Stream Management (Streamer and Watcher):

RTScreen, a possible component of the system 100 and system 100A, is an improved streaming protocol that enhances real-time streaming performance. RTScreen may comprise a streaming policy, protocol/s, or platform implemented completely in software on commercial off-the-shelf smartphones with Android and iOS and desktop computers with Linux, Windows and Mac OS (operating system) and connected with TCP/IP network through WiFi or Ethernet, and may be integrated with the application 102 or separately implemented. Any streaming device 104 and/or host machine of the devices 101 may be equipped with RTScreen via the application 102 (or a separate application) and can function as a streaming or receiving device in a screen sharing group.

The following remaining discussion is directed to implementation of RTScreen for streaming/sharing media content once the network 108 is formed among the devices 101 according to FIGS. 1-3. Once the network 108 is formed, and the streaming device 104 is ready for recording and sharing media content, a stream session may be configured. A stream session may include a streaming device 104 source which is referred to herein for the remaining discussion as a “streamer,” and at least one drain or receiving device 106, which is referred to herein for the remaining discussion as a “watcher” or “watchers,” with a quality configuration defining a set of session parameters associated with screen resolution, target frame rate, and encoder and decoder parameters. In some embodiments, the quality configuration does not change over time. The actual source of a stream session is referred to herein as a media object, which may include a video object and/or an audio object. Hence, a stream session can include a video stream session and/or audio stream session. A video object may function akin to a buffer that contains frames to be sent, where the frames are grabbed or otherwise accessed from the screen. The drain of a stream session is called either a renderer for screen frames or playback for audio segments. For example, a user can access RTScreen by opening or accessing the application 102 and creating two media objects, one for the screen with high resolution, and the other for the same screen with low resolution.

Multiple stream sessions may be generated between the same pair of a streamer and watcher to stream the same screen content, while each session may have different quality configurations. Each session may define a session id, typically an identifier associated with the same streamer. Hence, in a system with multiple streamers or with a broker (broker device 114), a stream session may be uniquely identified by the streamer name and the session id (or broker name and the session id) at the same time. Note that if the screen sharing involves one streamer, one broker and one watcher, two sessions are required—one from the streamer to the broker and the other from the broker to the watcher.

Different stream sessions can connect one or more watchers to the same media object or different media objects of one or more streamers. For example, if the streaming machine/device 104 has multiple screens, the watcher can create multiple video objects to stream these screens independently. However, this is the rare case. Typically, different video objects can contain frames from the same screen but with different quality parameters. Each media object may include a media object ID, usually a human understandable alphanumeric string with a suffix of quality level. Similar to the session ID, the media object ID is only meaningful to the same streamer. In a system with multiple streamers or with brokers, a media object must be uniquely identified by both the streamer name and the media object ID. The broker does not change the media object ID when forwarding the stream.

Software associated with the streamer and watcher may contain two planes (similar to an IP router): a data plane, and a management plane. The data plane is responsible for the transferring of the actual screen frame and audio using a UDP-based RTScreen data stream protocol; and the management plane is responsible for setting up and tearing down stream sessions as well as applying adaptive streaming policy via a TCP-based RTScreen management protocol as defined herein. As a result, similar to the stream session, there is a stream management session between a pair of a streamer and watcher (or streamer and broker, or broker and watcher), which is uniquely identified by a pair of streamer name and watcher name (or streamer name and broker name, or broker name and watcher name).

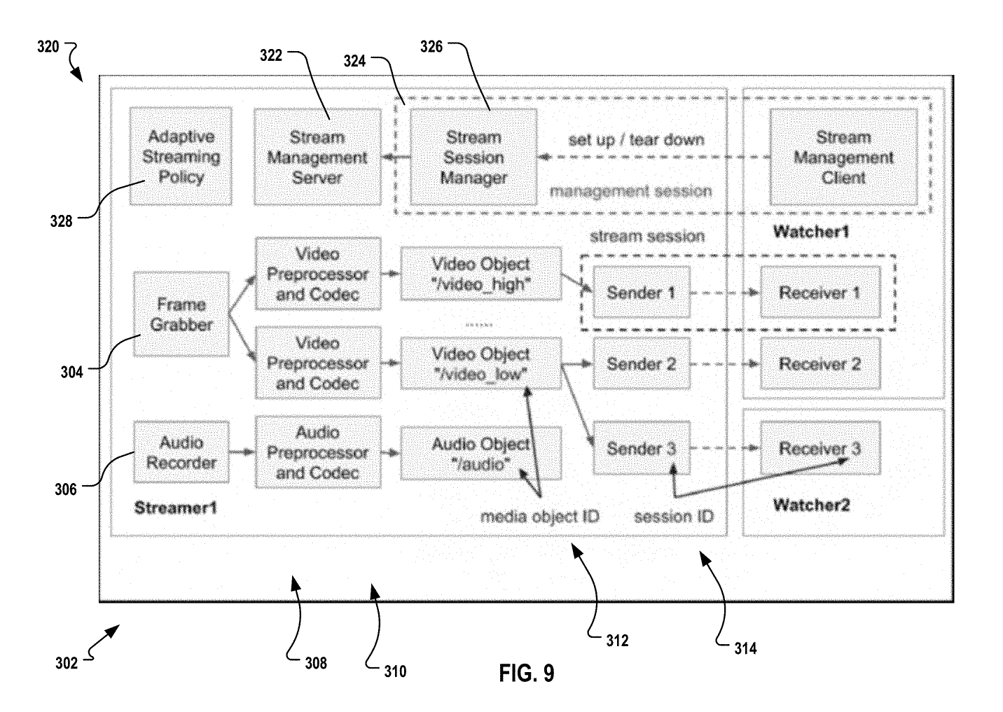

FIG. 9 illustrates possible components 302 of a data plane associated with a streamer. A streamer's data plane may include a screen frame grabber 304, an audio recorder 306, one or more media preprocessors 308 (video preprocessor or audio preprocessor), one or more media codecs 310 (video codec or audio codec), one or more media objects 312, and one or more stream senders 314. These components construct the producer/streamer half of the producer-consumer (streamer-watcher) stream pipeline. These components 302 are organized as a tree structure rooted at the screen frame grabber 304 or the audio recorder 306. Multiple stream sessions may be set up to stream frames from the same screen frame grabber 304 in different quality configurations.

FIG. 9 further illustrates possible components 320 of a streamer management plane. The components 320 may include a stream management server 322, one or more of a stream management session 324 each managed by a stream session manager 326, and an adaptive streaming policy/s 328. The stream management server 322 listens and accepts a new stream management session 324 from a stream management client on the watcher side, and sets up as well as tears down media stream sessions. The adaptive streaming policy 328 module is discussed below.

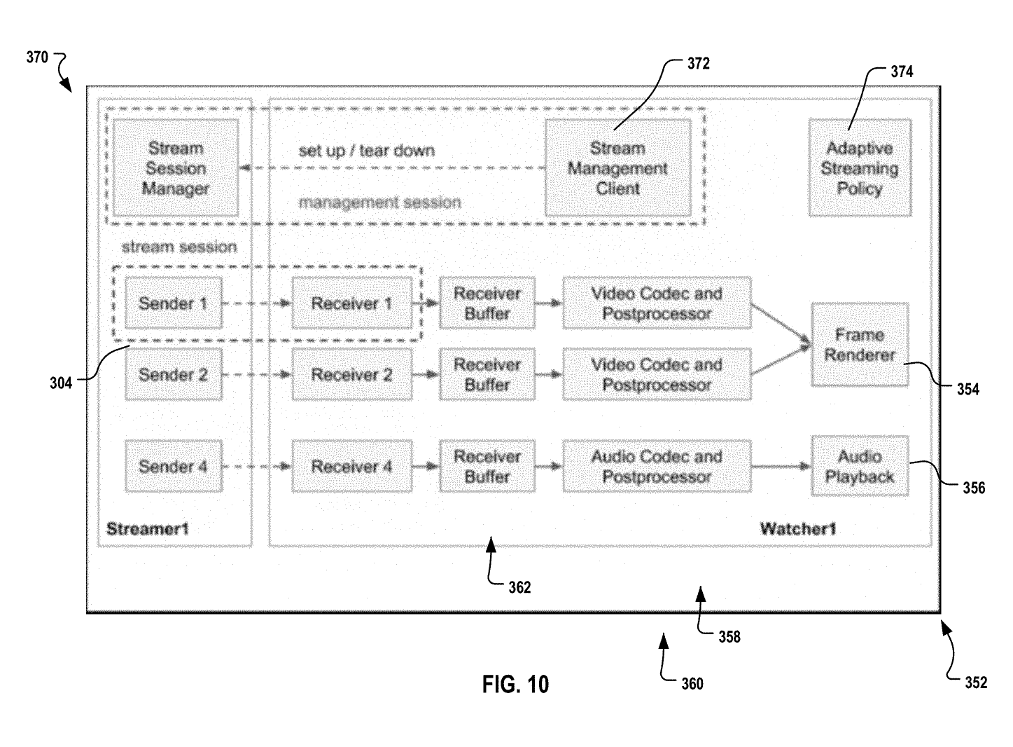

FIG. 10 illustrates possible components 352 of a data plane associated with a watcher. A watchers data plane may include a screen frame renderer 354, an audio playback 356, one or more media postprocessors 358 (video postprocessor or audio postprocessor), one or more media codecs 360 (video codec or audio codec), one or more media receiver buffer 362, and one or more stream receivers 364. These components 352 construct the consumer half of the producer-consumer (streamer-watcher) stream pipeline. They are organized as a reversed tree structure rooted at the screen frame renderer 354 or the audio playback 356. If multiple stream sessions are available for the frame renderer 354, it chooses from one session to render. This choice may be governed by the adaptive streaming policies described in greater detail below.

A watcher's management plane may contain components 370 including a stream management client 372 and an adaptive streaming policy 374. The stream management client 372 connects to the stream management server 322 on the streamer side. The adaptive streaming policy 374 module is discussed in greater detail below.

Procedure of Streaming and Messages:

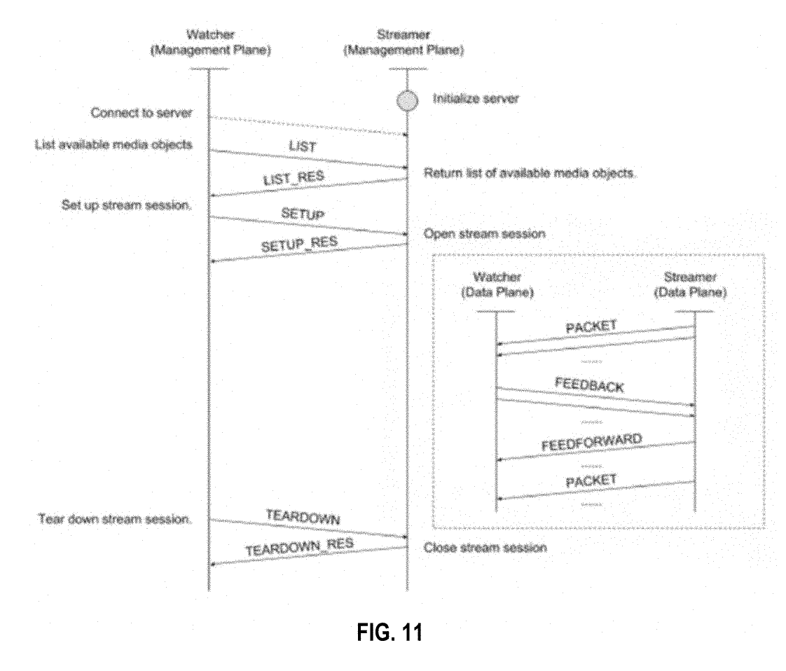

As previously described, the behavior of the streamer and the watcher may be categorized into two planes—the management plane and the data plane. Further, two independent protocols may be used for the two planes: a TCP based request-response style RTScreen management protocol for the management plane, and a UDP based RTScreen data stream protocol for the data plane. One possible procedure of streaming screen frames in the management plane is shown as follows, and also illustrated in FIG. 11:
1. The stream management client 372 of the watcher connects to the stream management server 322 of the streamer using the management protocol.
2. The stream management client 372 of the watcher sends a LIST message, requesting a list of available media objects.
3. The stream management server 322 of the streamer sends back a response of the LIST message, which contains a list of media objects associated with corresponding screens and their descriptions.
4. The stream management client 372 of the watcher sends a SETUP message, requesting to open a stream session on a specified media object. The setup message also contains a pair of UDP ports on the watcher for receiving packets of screen frame and send back feedback.
5. The stream management server 322 of the streamer returns a response of the SETUP message, indicating whether the stream session is successfully set up or not (mainly by checking whether the media object exists and whether the streamer has enough resource to provide the specified service level). The response to the SETUP message also contains a pair of UDP ports on the streamer for sending packets of screen frame and receive feedback.
6. In a successful case, the streamer opens a stream session and starts streaming. Once the stream session is set up, data streaming immediately starts.
7. The stream management client 372 of the watcher sends a TEARDOWN message, requesting to close a stream session on a specified media object.
8. The stream management server 322 of the streamer sends back a response of the TEARDOWN message, indicating whether the stream session is successfully teared down (mainly by checking whether the stream session exists).
9. The stream session can also be torn down (or just lost) in the data plane by the streamer or by the watcher without sending the TEARDOWN message and response in the management plane.
10. Optionally, if the streamer is connected to the proxy, the streamer can send an ADVERTISE message to the proxy to inform the proxy on the available media objects. The payload of the ADVERTISE message is the same as the response of the LIST message. The proxy will send back a response of the ADVERTISE message.

One possible procedure of streaming screen frames in the data plane is shown as follows, and also illustrated in FIG. 11:
1. The streamer sends PACKET messages of screen frames to the watcher.
2. The watcher sends FEEDBACK messages to the streamer. There are two types of FEEDBACK messages: one type is the FEEDBACK of each packet, which is sent back immediately upon receiving each PACKET message, and the other type is the FEEDBACK of a whole frame, which is sent back after the whole frame is received, decoded, and rendered.
3. The streamer sends FEEDFORWARD messages periodically that contains statistical information such as RTT (round trip time) and packet loss to help the watcher make adaptive streaming decisions.
4. If the streamer does not receive any FEEDBACK messages for a certain amount of time (typically 30 seconds), the streamer may send an emergent FEEDFORWARD message and tear down the session directly in data plane.
5. The watcher may send a FEEDBACK message with a special flag denoting that the session is going to be lost and tear down the session directly in data plane in case of an emergent condition.

Emergent conditions may be triggered by a user interface (UI) of the application 102; e.g., the app is closed, or switched to background, etc.

Referring to FIG. 11, it should be noted that the management protocol itself is stateless; i.e., one request and one response and the requests do not depend upon one another. The watcher does not need to send LIST before SETUP if the media object ID is already known. Also, the watcher may disconnect the management session after the response of SETUP is received, and later reconnect to send TEARDOWN. Once the stream session is set up, the name of the streamer and the session ID may be kept on both sides and explicitly transmitted in each message. Further, in some embodiments, no flow control mechanism is build into the data stream protocol. However, the FEEDBACK and FEEDFORWARD messages built within RTScreen provide a mechanism that can be used to implement adaptive bitrate streaming, which serves as a flow control function in most cases, and is further described herein.

Details of Data Plane and Timing:

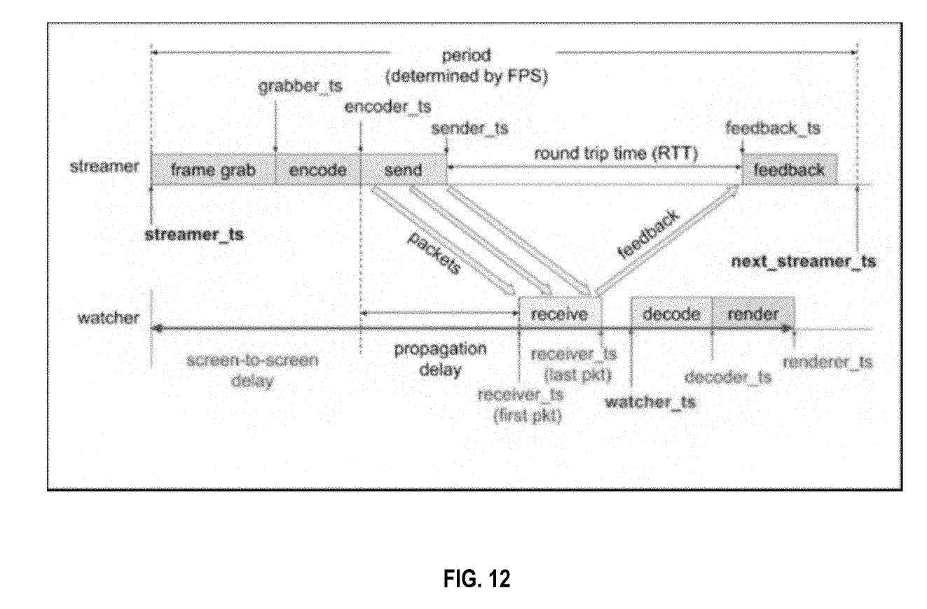

Referring to FIG. 12, data plane and timing and one possible procedure for streaming screen frames in the data plane will now be described as follows:
1. Timer triggers the streamer process to wake up. This timer is called the streamer timer.
2. The streamer grabs/records a frame of the screen.
3. The streamer preprocess and encode the frame (into multiple service levels with different resolutions and target bitrate).
4. The streamer packetizes the frame and sends packets to the watcher.
5. The streamer goes to sleep, waiting for the next frame to be grabbed.
6. The watcher receives each packet of the frame and sends back packet-level feedback, immediately upon each packet is received. The received packets are put into a receiver buffer to reconstruct the whole frame.
7. Timer triggers the watcher process to wake up. This timer is called the watcher timer.
8. The watcher retrieves a whole frame from the receiver buffer if the frame has arrived and on time (defined later). Then, the watcher decodes the frame. If the screen frame renderer is connected with multiple stream sessions, the watcher retrieves a frame from the buffer associated with each session and decodes them. If the frame has not arrived or the current time is early for the frame (defined later), the watcher will simply skip this iteration. If the frame arrives late (defined later), the frame is skipped.
9. The watcher renders the frame on the screen.
10. The watcher goes to sleep, waiting for the next frame to be rendered.
11. Go to step 1

The streaming of audio may be conducted using a similar procedure.

According to a possible timing model of RTScreen, it is assumed that the streamer and the watcher are synchronized with the same clock in millisecond precision (for the convenience of explanation). This possible timing model is defined as follows:
1. “streamer_ts” is defined as the timestamp immediate after the streamer process is woke up by the streamer timer. “streamer_ts(i)” is used to denote the timestamp of the ith frame if a sequence of frames are discussed in the context.
2. “grabber_ts” is defined as the timestamp immediate after the frame grabbing finishes and the grabbed frame is returned. “grabber_ts(i)” is used to denote the timestamp of the ith frame.
3. “encoder_ts” is defined as the timestamp immediate after the frame encoding finishes. “encoder_ts(i, j)” is used to denote the timestamp of the ith frame in the jth quality level.
4. “sender_ts” is defined as the timestamp immediate after each packet is sent. “sender_ts(i, j, k)” is used to denote the timestamp of kth packet of the ith frame in the jth quality level. “sender_ts(i, j)” is also used to denote the timestamp of the ith frame in the jth quality level, which is the timestamp immediate after the last packet of the frame is sent.
5. “receiver_ts” is defined as the timestamp immediate after each packet is received. “receiver_ts(i, j, k)” is used to denote the timestamp of kth packet of the ith frame in the jth quality level. “receiver_ts(i, j)” is also used to denote the timestamp of the ith frame in the jth quality level, which is the timestamp immediate after the last packet of the frame is received.
6. “watcher_ts” is defined as the timestamp immediate after the watcher process is waked up by the watcher timer. Note that sometimes the watcher may be waken up but doing nothing in the iteration because no frame is ready to render. Due to this reason, “watcher_ts(i)” is not defined.
7. “decoder_ts” is defined as the timestamp immediate after the frame decoding finishes. “decoder_ts(i, j)” is used to denote the timestamp of the ith frame in the ith quality level. Note that if the frame is not decoded because of overrun, decoder_ts is just watcher_ts.
8. “renderer_ts” is defined as the timestamp immediate after the frame rendering finishes (from the perspective of the watcher process) and the renderer API returns. “renderer_ts(i)” is used to denote the timestamp of the ith frame. Note that if the frame is not rendered, renderer_ts is just decoder_ts.

On the streamer side, a presentation time may be attached to each frame and sent along with the frame to help the watcher render the frames smoothly. Typically, the presentation time of a frame is just the grabber_ts.

On the watcher side, a frame has “arrived” if a certain percentage of the whole frame is received. This percentage is a parameter of the watcher (typically set to 95%). On the watcher side, for each iteration, the “current time” is typically defined as the watcher_ts A frame may be considered timely or “on time” if the current time matches the presentation time with a specified delay, as further described herein.

Message Format of the RTScreen Data Stream Protocol:

In one embodiment, the RTScreen Data Stream Protocol is a stateless binary protocol based on UDP. The streamer and the watcher mainly exchange three types of message: PACKET of screen frame or audio segment, FEEDBACK from the watcher to the streamer, and FEEDFORWARD from the streamer to the watcher containing important statistics that assist the adaptive streaming policy. Each type of message has a few variations for different purposes. A list of possible messages are provided below:
PACKET of screen frame
FEEDBACK of individual PACKET of screen frame
FEEDBACK of a whole screen frame
FEEDFORWARD of a whole stream session (periodical)
FEEDFORWARD of a whole stream session (emergent)

In some embodiments, a few rules may be implemented for message format as follows: all integer fields in the messages may be little endian; and all timestamps and all types of round trip time may be in milliseconds.

Packet of a Screen Frame:

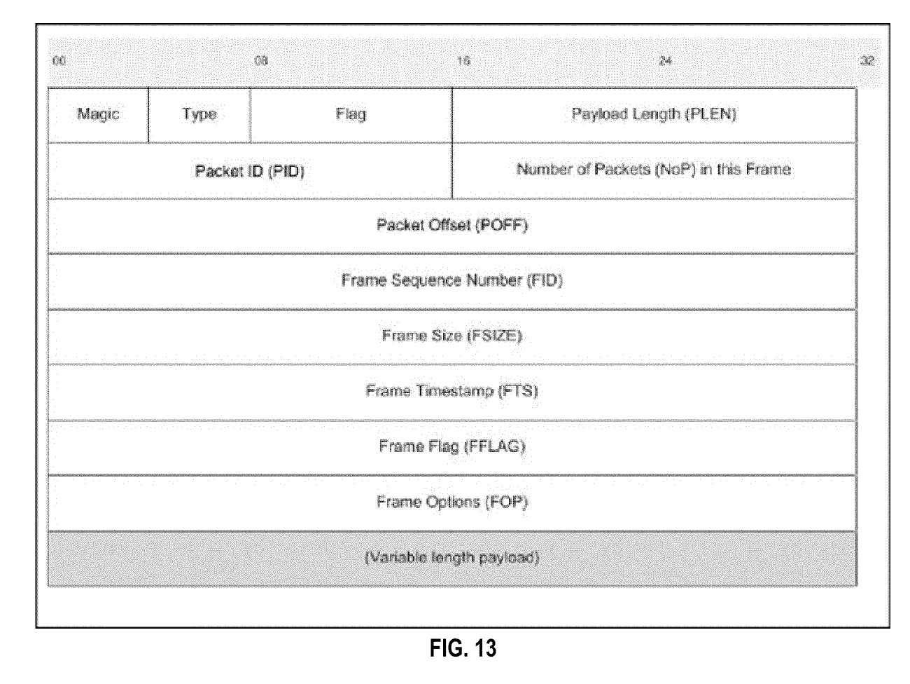

As mentioned above, a screen frame may be encoded, packetized, and transmitted from a streamer (streaming device 104) to a watcher (receiving device 106). One possible format of the packet of a screen frame is illustrated in FIG. 13. A few fields are explained as below:
Magic (4 bit): a magic number, also used to distinguish protocol version and compatibility, always set to 0x4 in current version.
Type (4 bit): the type of the packet. For PACKET of screen frame, it is set to 0x0
FLAG (8 bit): a flag denoting the media type and encoding type of the payload. Currently value of this field includes:
   0x00: video with each frame independently encoded in JPEG.
   0x01: video encoded in H.264.
PLEN (16 bit unsigned integer): the actual payload length (without the padding for encryption). The maximum length of a PACKET message is 65535 including the header (UDP datagram size restriction). Thus, the maximum of this field is a little less than that.
PID (16 bit unsigned integer): packet ID. A frame may be packetized to multiple packets, and this field denote the packet ID within a frame. For example, if a frame is packetized to 20 packets, PID will be set from 0 to 19.
NoP (16 bit unsigned integer): Number of Packets (NoP) in this frame. For example, if a frame is packetized to 20 packets, NoP will be set to 20. A frame can have at most 65535 packets.
POFF (32 bit unsigned integer): packet offset in byte. For example, if a frame is 2000 bytes and packetized to 20 packets, the byte offset of each packet will be 0, 100, 200, etc.
FID (32 bit unsigned integer): the sequence number of this frame in the stream.
FSIZE (32 bit unsigned integer): the size of this frame in byte. For example, if a frame is 2000 bytes, FSIZE of the packets of this frame is all set to 2000. Theoretically, the maximum frame size can be 4 GB. In current implementation, a frame can be at most 1 MB large (encoder restriction).
FTS (32 bit unsigned integer): the presentation time of this frame. If this time is in millisecond, it will wrap around in over 1,000 hours, long enough for our application.
FFLAG (32 bit unsigned integer): the flag of the frame. Currently, if the frame is a key frame, the most significant bit is set to 1. Otherwise, the most significant bit is set to 0. Other bits are not used currently.
FOP (32 bit unsigned integer): an option field used by the codec. Currently it is not used.
variable length payload: the actual packetized frame data.

FEEDBACK of Individual Packet of Screen Frame:

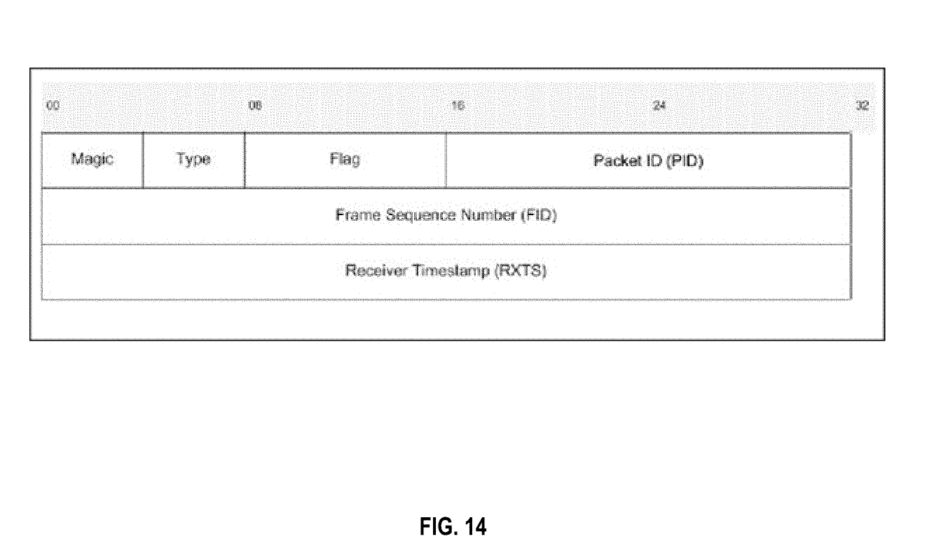

The feedback of an individual packet of a screen frame may be in the form of a FEEDBACK message sent by the watched/receiving device 106 immediate upon the receiving of each PACKET message. One possible format is illustrated in FIG. 14. A few important fields are explained as below:
Magic (4 bit): a magic number, also used to distinguish protocol version and compatibility, always set to 0x4 in current version.
Type (4 bit): the type of the packet. For packet of screen frame, it is set to 0x1.
Flag (8 bit): flag of the frame. Not used currently.
PID (16 bit unsigned integer): packet ID, same as the packet ID of the corresponding PACKET message.
FID (32 bit unsigned integer): the sequence number of this frame in the stream, same as the frame sequence number of the corresponding PACKET message. PID and FID together indicate which packet this feedback is about.
RXTS (32 bit unsigned integer): receiver timestamp, the timestamp on the watcher immediate upon the receiving of the corresponding PACKET message. This field is used to synchronize the clock of the streamer and the clock of the watcher.

FEEDBACK of a Whole Screen Frame:

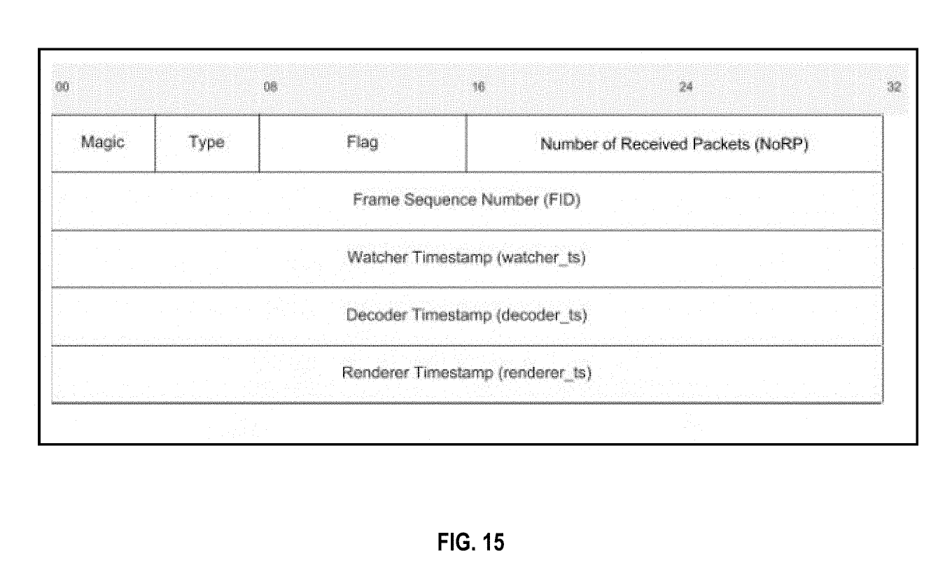

The feedback of individual packet of screen frame is a FEEDBACK message sent by the watched/receiving device 106 after the whole frame is rendered. The format is illustrated in FIG. 15. A few important fields are explained as below:
Magic (4 bit): a magic number, also used to distinguish protocol version and compatibility, always set to 0x4 in current version.
Type (4 bit): the type of the packet. For packet of screen frame, it is set to 0x2.
Flag (8 bit): flag of the frame. Not used currently.
NoRP (16 bit unsigned integer): Number of received packets of this frame.
FID (32 bit unsigned number): the sequence number of this frame in the stream.
watcher_ts (32 bit unsigned integer): the timestamp of watcher waking up, exactly the same as the watcher_ts in the timing model.
decoder_ts (32 bit unsigned integer): the timestamp at finishing decoding of the frame, exactly the same as the decoder_ts in the timing model.
renderer_ts (32 bit unsigned integer): the timestamp at finishing rendering of the frame, exactly the same as the renderer_ts in the timing model.

FEEDFORWARD of a Whole Stream Session (Periodical):

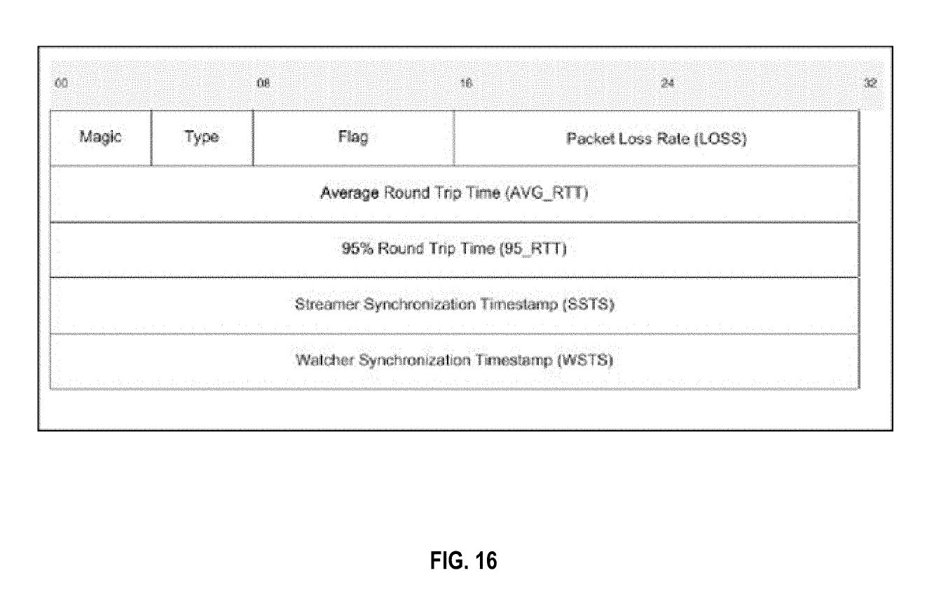

The periodical feedforward of a whole stream session may be sent by the streamer to the watcher, mainly to deliver timing and congestion related information to help the watcher make adaptive streaming decisions. One possible format (periodical) is illustrated in FIG. 16. A few important fields are explained as below:
Magic (4 bit): a magic number, also used to distinguish protocol version and compatibility, always set to 0x4 in current version.
Type (4 bit): the type of the packet. For packet of screen frame, it is set to 0x3.
Flag (8 bit): flag of the frame. Not used currently.
LOSS (16 bit fixed point number): packet loss rate, as a fixed point number with two digits after the decimal point. For example, if the packet loss rate is 12.34%, this field is 1234.
AVG_RTT (32 bit unsigned integer): average round trip time (in the last period).
95_RTT (32 bit unsigned integer): a round trip time bound such that RTT of 95% of packets is within this bound, ignoring lost packets.
SSTS: a timestamp of a synchronization point on the streamer side corresponding to the WSTS on the watcher.
WSTS: a timestamp of a synchronization point on the watcher side corresponding to the SSTS on the streamer.

FEEDFORWARD of a Whole Stream Session (Emergent):

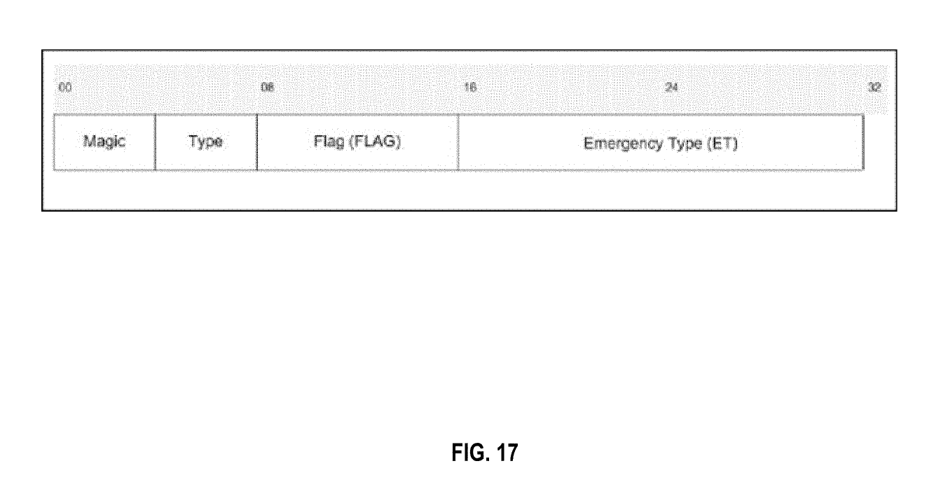

The emergent feedforward of a whole stream session is sent by the streamer to the watcher, usually denoting emergency conditions that require tearing down the stream session (or downgrade the stream session, which is essentially the same as tearing down this session). One possible format is illustrated in FIG. 17. A few important fields are explained below:
Magic (4 bit): a magic number, also used to distinguish protocol version and compatibility, always set to 0x4 in current version.
Type (4 bit): the type of the packet. For packet of screen frame, it is set to 0x4.
Flag (8 bit): flag of the frame. Not used currently.
ET (16 bit unsigned integer): emergency type code.

Message Format of the RTScreen Management Protocol:

In one embodiment, the RTScreen management protocol is a text based protocol with payload of JSON objects. It is a stateless request-response protocol. Possible messages may include the following:
LIST message and its response
ADVERTISE message and its response
SETUP message and its response
TEARDOWN message and its response

LIST message

The List message allows the watched to browse the available media objects on a streamer or a proxy. The format of the LIST message is shown as follows:

{
“message” : “LIST”
}

Response of the LIST Message

The response of the LIST message provides the watcher a list of available media objects, so that the watcher can set up stream session associated with one or more of them. The format of the response of LIST message may be as follows:

```
{
    “message” : “LIST_RES”
          “media_objects” : [
          “ID” : “ video_FAST1 ”, “service_level” : “ 2 ”, “sync_seq” : “ 1 ”,
          “desc” : “ XXX ”,
          “ID” : “ video_SD ”, “service_level” : “ 5 ”, “sync_seq” : “ 1 ”, “desc” :
          “ XXX ”,
          “ID”: “ audio_64 ”, “service_level” : “ 3 ”, “sync_seq” : “ 1 ”, “desc” : “
          YYY ”,
    ]
}
```

The response of the LIST message may contain a list of media objects (it might be empty if no media object is provided by the streamer, which is a rare case). Each list item contains at least four fields: an “ID”, a “service_level”, a “sync_seq” (synchronization sequence, media objects with the same sync_seq has the same reference of presentation time), and a “desc” (description text). Besides, the list item should also provide “frame_width”, “frame_height”, “target_fps”.

ADVERTISE Message

The response of the ADVERTISE message provides the proxy a list of available media objects, so that the proxy can set up stream session associated with one or more of them. The format of the response of the ADVERTISE message is shown as follows, which is almost the same as the response of the LIST message:

```
{
    “message”: “ADVERTISE”
    “media_objects” : [
            “ID” : “ video_FAST1 ”, “service_level” : “ 2 ”, “sync_seq” : “ 1 ”, “desc” :
          “ XXX ”,
            “ID” : “ video_SD ”, “service_level” : “ 5 ”, “sync_seq”: “ 1 ”, “desc”: “
          XXX ”,
            “ID” : “ audio_64 ”, “service_level” : “ 3 ”, “sync_seq” : “ 1 ”, “desc” : “
          YYY ”,
    ]
}
```

Response to ADVERTISE Message

The response to the ADVERTISE message is sent by the proxy, which is just a confirmation of the delivery of the ADVERTISE message, illustrated as follows:

```
{
    “message” :
    “ADVERTISE_RES”,
    “error” : “ None ”
}
```

SETUP Message

The watcher sends a SETUP message to set up a stream session. The format of the response of the SETUP message is shown as follows:

```
{
    “message” : “SETUP”,
    “media_object_id” : “ video_FAST1 ”,
    “ip_address” : “ 192.168.0.1 ”,
    “stream_port” : “ 32000 ”,
    “feedback_port” : “ 32001 ”,
    “nonce” : “ 989426a69ab3f3d033870e200d93e9a4 ”
}
```

The “media_object_id” is the ID of the media object (usually obtained from the response of the LIST message). The “ip_address” is the IP address of the watcher to receive the stream. The “nonce” is a randomly generated 128 bit number to help both ends to generate cryptographic key to encrypt the streaming data.

Response to SETUP Message

The streamer sends a response of the SETUP message to finish the stream session set up. Once this message is sent out, the streamer may start sending PACKET messages to the designated IP address and the port. The format of the response of SETUP message may be as follows:

```
{
    “message” : “SETUP_RES”,
    “error” : “ None ”,
    “session_id” : “ 1 ”,
    “ip_address” : “ 192.168.0.1 ”,
    “stream_port” : “ 31000 ”,
    “feedback_port” : “ 31001 ”,
    “nonce” : “ 3f8e9a209ad93496a6089b70e423d033 ”
}
```

The “error” is an error code. If it is “None”, remaining fields will actually appear in thi smessage. Otherwise, this field denotes the error reason and the session is not set up. “session_id” is the session ID. “ip_address” is the IP address of the streamer to send the stream. The “stream_port” is the UDP port of the streamer to send the stream, and the “feedback_port” is the UDP port of the sender to receive feedback. It should be noted that these same names of ports means different things for the streamer and the watcher. The “nonce” is a randomly generated 128 bit number to help both ends to generate cryptographic key to encrypt the streaming data, similar as the “nonce” in the SETUP message.

It should be further noted that session set up and tear down will be different if the proxy is used, because usually in this case the streamer and the watcher does not possess public IP address and their TCP and UDP flows must be initiated by the streamer and the watcher to reach the proxy.

TEARDOWN Message

The TEARDOWN message is sent by the watcher to tear down an existing stream session. The format of TEARDOWN message is shown as follows:

```
{
      “message” :
    “TEARDOWN”,
    “session_id” : “ 1
    ”
}
```

The “session_id” is the ID of the stream session, usually obtained by the SETUP message.

Response of TEARDOWN Message

The response of the TEARDOWN message is sent by the streamer to confirm tearing down an existing stream session. The format of the response of TEARDOWN message is shown as follows:

```
{
      “message” :
    “TEARDOWN_RES”,
    “error” : “ None ”
}
```

It should be noted that the TEARDOWN message is not necessarily required to tear down a stream session. Stream session may be torn down directly in the data plane.

### RTScreen Features for Improving Real-Time Streaming Quality

The following technologies were developed as part of RTScreen and the application 102 to improve the real-time streaming quality between the devices 101, collectively shown in Table 1. Using feedback and/or feedforward control messages, all following technologies are implemented in the adaptive streaming policy modules on the streamer side and the watcher side to improve real-time streaming performance (including latency reduction and throughput improvement). These modules work in concert to make decisions periodically or upon an event to achieve a common objective—smooth low delay stream with good resolution. In some embodiments, smoothness is the top priority, i.e., no stuck of frame for buffering or frame corruption. Low screen to screen delay may be the next priority. Streaming resolution may have a lower priority. As a result, the policy module may take effect by adaptively changing parameters of the underlying streaming mechanisms (such as frame rate, receiver buffering delay, quality level, etc.) provided by the protocol and the implementation to achieve these goals from different perspectives.

TABLE 1
Technologies to improve the real-time streaming quality

| | which side | |
|---|---|---|
| technology | makes decision | influence |
| adaptive frame rate | sender | multiple streams |
| adaptive packetizating-duplication- | sender | single stream |
| retransmission | | |
| automatic delay control | receiver | single stream |
| multilevel adaptive bitrate streaming | receiver | single stream |
| packet scheduling and traffic shaping | sender | multiple streams |
| overrun control | both | multiple streams |

A summary associated with each core technology or technological feature of RTScreen is as follows:
Adaptive frame rate: decrease frame rate to save bandwidth if the screen does not change significantly.
Adaptive packetizating-duplication-retransmission: increase the chance of delivery of the key frames. Key frame may b defined by the codec, e.g., in H.264 an I-frame is a key frame.
Automatic delay control: decrease the delay if the network condition is good, i.e., bandwidth is enough and round-trip-time is small.
Multilevel adaptive bitrate streaming: encode the video in different levels and ask the receiving device 106/watcher to choose the best quality level according to available network capacity and local resources (akin to a flow control and congestion control method).
Packet scheduling and traffic shaping: prioritize low service level and buffer burst traffic to ensure that low resolution frames can still be delivered and played smoothly in case of network congestion.
Overrun control: reduce workload by dropping frames under overrun if more frames are there than the processing capability.

Adaptive Frame Rate:

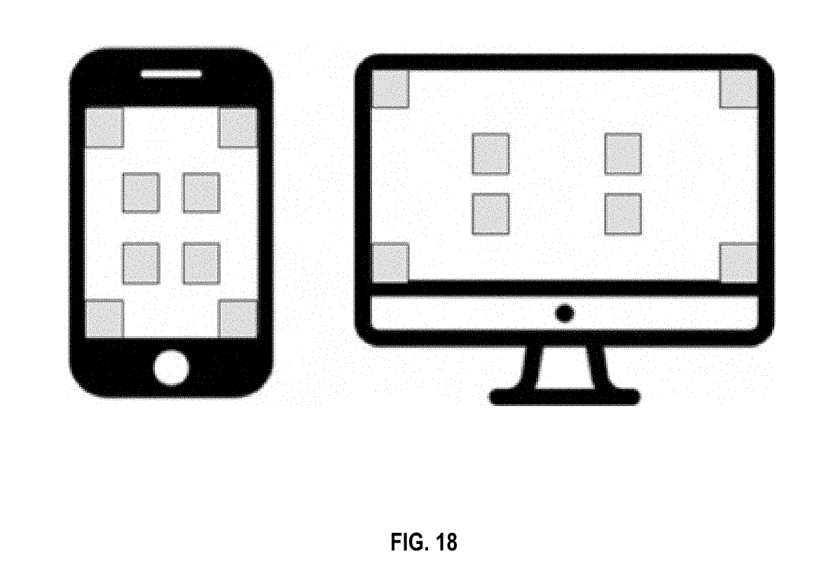

In one embodiment, RTScreen includes an Adaptive Frame Rate feature where the streamer detects how much the screen content changes. Referring to FIG. 18, for a screen frame example utilizing the Adaptive Frame Rate feature, 8 small blocks on the screen may be defined, four on the corner, and four on the corner of a rectangle located at the center of the screen and may include a size of ¼ of the screen. Each block may be 16 pixel by 16 pixel in size. The screen content may be defined as “almost not changing” if 7 out of these 8 blocks do not change from the previous frame to the current frame. This situation happens when the screen being streamed/shared contains static content and is limited to cursor moves. Similarly, the screen content may be defined as “changing significantly” if more than 1 blocks out of these 8 blocks changes from the previous frame to the current frame. Screen content change detection may be applied on every frame. As a result, for every frame, the screen content may be interpreted as being either in “almost not changing” mode or in “changing significantly” mode.

The streamer may adjust the frame rate according to the extent of the screen content change. Typically the default rate may be 30 frames per second, and it can be configured on the streamer side. Typically a key frame can be enforced for every 30 frames. When the screen content is detected to be in almost not changing mode, the frame rate can be decreased by half for every one second, until one frame per second. However, if the screen content is detected to be in “changing significantly” mode, the rate may be immediately restored to the default streaming rate, and a key frame may be injected.

As a result, if the screen does not change significantly or does not change at all, which is common in streaming desktop or in some apps Apps where the UI maintains a similar image content, the transmission bandwidth consumption is significantly reduced.

Adaptive Packetizing-Duplication-Retransmission:

In one embodiment, implementing the present feature under RTScreen, each frame may be packetized with a packet size typically ranging from 192 byte to 1472 byte with an increment of 32 byte (mainly for the convenience of encryption). For the key frames where the influence of packet loss is more significant, the packet size is determined by the quality of the communication channel indicated by packet loss rate and RTT. The more lossy the link is, the smaller the packet size is used. For video codecs such as H.264, the codecs may also be instructed to generate NAL (network abstraction layer) Units of smaller size. This scheme may also work without the assistance of codecs and even agnostic of the bit stream after encoding.

A rule of thumb on packet size: size=base size/(1+k1*loss rate+k2*RTT). Here base_size is typically the maximum packet size configured on the streamer, loss_rate is the packet loss rate in percentage, and RTT is the round trip time, while k1 and k2 are two parameters obtained from empirical results. If the calculated packet size is less than the minimum packet size configured on the streamer, it is set to the minimum packet size.

Besides general packetization, the sender may actively duplicate the packets for sending a frame, i.e., send the same packet twice, in the hope that as long as one packet is received on time, the stream can be played smoothly. To avoid burst loss, the duplicated packets are sent out of order in a random fashion. Additionally, the sender may retransmit a packet if the feedback is not received within a short time period, typically 15 ms to (1000/FPS) ms. A packet may be retransmitted at most once.

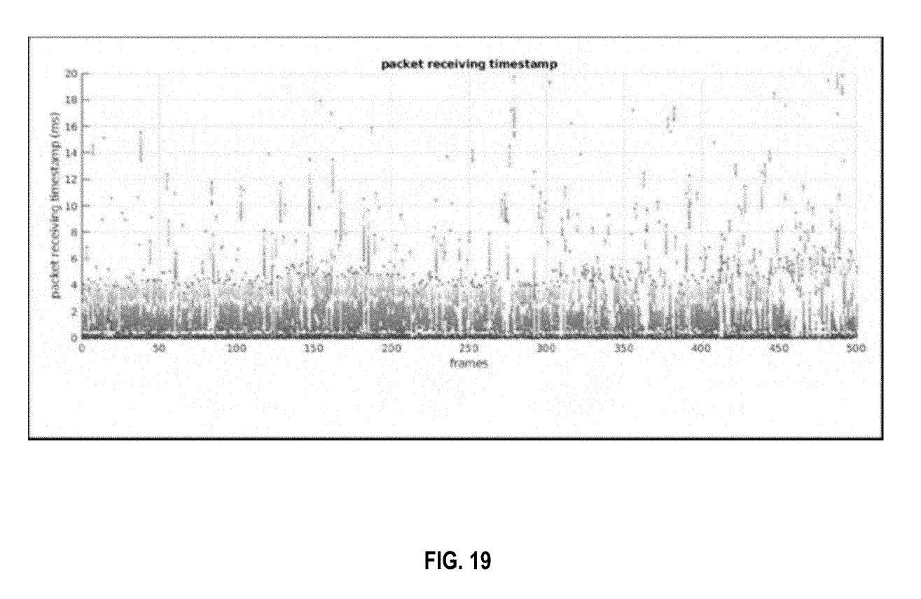

The rationale behind packet duplication and retransmission is that given the uncontrollable delay of the link, esp., link with one or more wireless hops, and given the independence of the delay of packets, more attempts in packet level may help the delivery of the whole frame in time. An example of packet receiving timestamps is shown in FIG. 19. In this figure, the receiving timestamp of each packet in a frame relative to the receiving of the first packet of the frame (i.e., receiver_ts(i, j, k)−receiver_ts(i, j, 1)) is plotted respect to the frames (i.e., respect to i). The color indicates the sequence of the packets, from first packet (cold color in blue) to later packet (warm color in yellow). It can be observed most packets are received within 6 to 10 ms after the first packet. However, some packets are delayed in a row, while the last packet (red dot in the figure) can be delayed significantly. In this experiment, the frame is not encoded, so every frame has the same amount of packets. It is believed that active duplication and retransmission can lead to more prompt packet delivery.

In some embodiments, this technology applies only to key frames in low service level to mainly cope with high jitter in the network transmission by achieving lower delay with higher bandwidth consumption. In H.264, key frames also include the SPS (sequence parameter set), PPS (picture parameter set), and other NAL Units that help the codec to stay synchronized. It should be noted that this may actually consume more network bandwidth.

Automatic Delay Control:

The present technology controls the buffering delay on the watcher side. To illustrate further, the following discussion elaborates on timing.

On the watcher side, for each iteration, the watcher process is woken up by the watcher timer and check whether there is a frame received and ready to be shown on the screen. Previously it is assumed the streamer and the watcher are synchronized with the same clock in millisecond precision. In reality, the clock on the streamer and the clock on the receiver cannot be synchronized perfectly, since they have different definition of time at 0. As a result, the watcher implementation will associate its clock to the streamer, typically at the arrival of the first packet of the first session. For multiple sessions of the same content in different service levels, the streamer is responsible to maintain the consistency of all presentation time (i.e., all presentation time of these sessions have the same reference of time at 0). This allows convenient mixing of the audio stream with the video stream or switching from one video stream of a certain quality to another video stream of another quality of the same content.

For simplicity, consider there is only one streamer-watcher pair; and on the watcher side, the clock association may function as follows:
1. Upon the arrival of the first packet of the first session from the streamer, the watcher records the local time as “local_t0” and the presentation time of the frame in this packet as “remote_t0” The assumption is that the propagation time of this packet is negligible, so local_t0 on the watcher corresponds to remote_t0 on the streamer.
2. For each packet after that, the relative presentation time is calculated by the presentation time of the frame in the packet minus remote_t0. The original presentation time in the packet is also called the absolute presentation time.
3. The relative current time is calculated by the watcher_ts minus local_t0. watcher_ts is also called absolute current time.
4. local_t0 and remote_t0 can be calibrated later using the synchronization timestamps in the FEEDFORWARD message. The streamer calculates these synchronization timestamps based on the round trip time and the timestamp in the FEEDBACK message.

For a system with multiple streamers and multiple watchers, relative presentation time and relative current time are defined for each streamer-watcher pair on the watcher side. The absolute presentation time is defined by each streamer and it does not change from watcher to watcher.

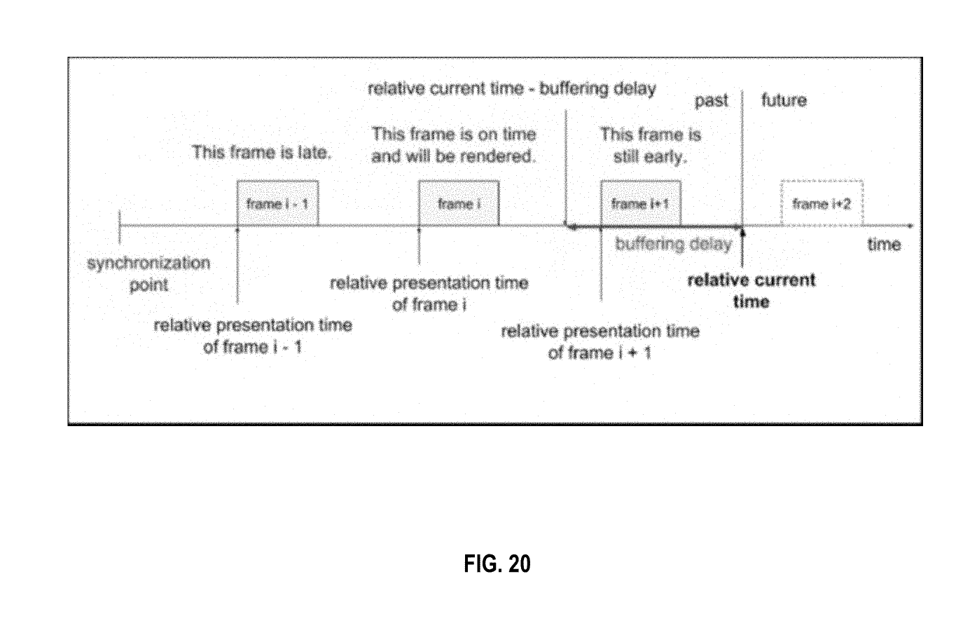

For the watcher, a frame is delivered (or a frame arrives at the watcher) if a large portion (typically 95%) of the frame is received. A frame is “on time” if relative current time−buffering delay≥relative presentation time (of this frame) and the frame is “not late.” A frame may be deemed late if its immediate next frame also satisfies the previous relation, shown in FIG. 20.

Similarly, a frame may be considered to still be early if the relative current time is less than the presentation time of the frame plus the renderer delay. Usually the watcher process wakes up regularly at the target frame rate. However, it can wake up early if the stream does not maintain constant frame rate. Due to the existence of buffering, the watcher will always delay the rendering of the frame to a certain extent for buffering enough amount of packets. As long as the delay is enough small, human users will not be able to feel it. The buffering delay is a parameter of the watcher, which can be dynamically changed by the watcher by the following algorithm:
1. The buffering delay is initially set to a default value (typically 50 ms).
2. In every iteration, if a frame is on time but not delivered, i.e., the packets do not have enough buffering time to be received, the buffering delay is multiplied by S (typically S is between 1.5 to 2) until a maximum is reached (typically 200 ms).
3. If in the past K frames (typically 30 frames), all frames are delivered on time, the delay is decrease by a constant value R (typically 15 ms) until a minimum is reached.
4. The minimum delay is initially set a default value (typically also 50 ms) and dynamically updated every a few seconds (typically upon every FEEDFORWARD message as the 95_RTT/2).

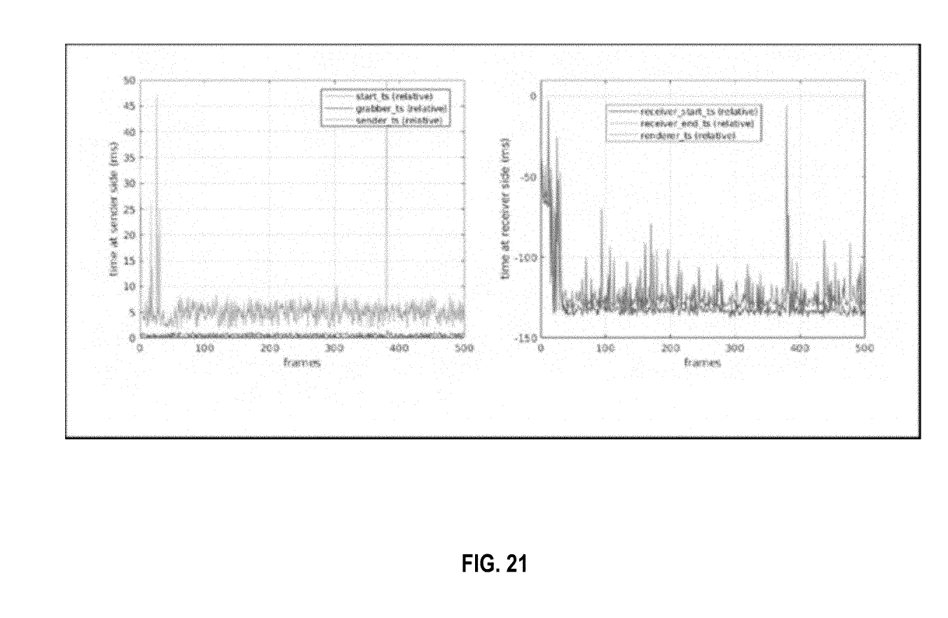

FIG. 21 shows an example of the delays on the streamer side (left) and the watcher side (right). Compared with the previously discussed timing model, it can be observed that the time consumed by frame grabbing and sending is negligible, while the delay is mainly caused by the packet propagation in lower network and transmission layers. As a result, the watcher must wait for buffering. In the right diagram of FIG. 21, the buffering time is set to 50 ms at the beginning, and adaptively changed to 150 ms after about 20 frames. As a result, within the buffering delay, the majority of the frames can be delivered, even some frames arrive after 30 ms to 50 ms after sending, which is still in the buffering window. In this example the buffering delay is never decreased (for demonstration purpose) and the frame rate is constant at 15 FPS. However, it can be observed that if the delay is decreased to around 70 ms, most frames can still arrive in time.

Automatic delay control also mitigates packet jitter from a different perspectivelt does not interfere with retransmission because the delay here means rendering delay respect to the frame grabbing time, not related to the delay of packet feedback (which is always sent immediately upon a packet is received).

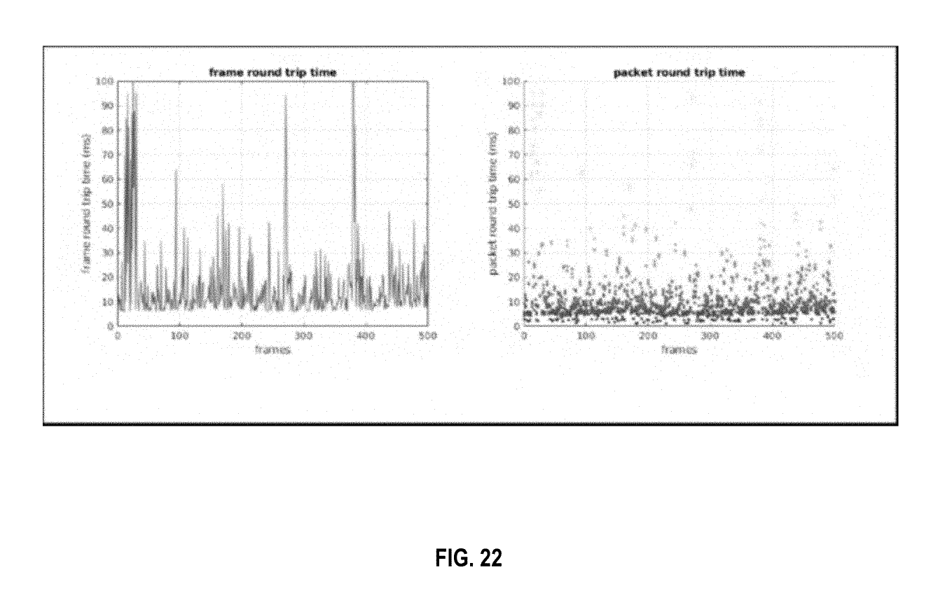

The rationale behind automatic delay control is based on the packet propagation delay and jitter, which can be inferred from RTT. FIG. 22 shows an example of measured RTT of the packets of 500 frames.

Multilevel Adaptive Bitrate Streaming:

Since RTScreen mainly targets screen sharing on mobile devices such as smartphone and laptop with wireless connection, a multilevel adaptive bitrate streaming technology was developed. This technology is different from the adaptive bitrate streaming technologies designed for video-on-demand website, which segment the video and encode the segments into multiple levels ahead of time. Instead, our method is segment: less and the encoding is done on the fly. Note that online video can use much more capable servers than our streamer, which is typically on a smartphone or a laptop. In this case, it is desirable to monitor in real time the resource limit on both the streamer and the watcher, as well as the network capacity to make a decision on the service level. Our adaptive bitrate streaming method contains mainly five parts:
1. Multiple service levels: The streamer can encode the frames in multiple levels (if a streaming session is requesting frames on a certain level), and the watcher select one of the service levels and receive encoded packets from that level.
2. Congestion detection and link capacity estimation: Both the streamer and the watcher use the information in the FEEDBACK message and the FEEDFORWARD message to detect congestion and estimate the link capacity.
3. Local resource limit estimation: Both the streamer and the watcher gather the hardware resource information including CPU, memory, hardware decoder, etc., and set a limit on the highest possible service level. Note that the streamer may decrease the limit if the number of connected watchers increases.
4. Service upgrade: The stream session starts at a default level provided by the streamer or a selected level specified by the watcher. The watcher can set up another stream session with higher service level and switch to that session, if link capacity and local resource allow that level, and no congestion is detected.
5. Service downgrade: The watcher can set up another stream session with lower service level and switch to that session, if congestion is detected or the link capacity is estimated to become worse. The streamer may send recommendation to downgrade in the FEEDFORWARD message. However, the decision is made by the watcher.

Possible service levels are listed in Tables 2, 3, 4, 5 below for screen frames of different ratio.

TABLE 2
Streaming Service Level for 16:9 screen frame

| | | | | | raw RGB | YUV 4:2:0 | compressed | bandwidth | |
|---|---|---|---|---|---|---|---|---|---|
| | | width | height | pixels | frame size | frame size | frame size | @30 fps | compression |
| # | name | (pixel) | (pixel) | (k) | (KB) | (KB) | (KB) | (kbps) | ratio |
| 1 | MIN | 128 | 72 | 9.2 | 27 | 14 | 0.16 | 39 | 84 |
| 2 | FAST1 | 256 | 144 | 36.9 | 108 | 54 | 0.65 | 155 | 84 |
| 3 | FAST2 | 384 | 216 | 82.9 | 243 | 122 | 1.45 | 348 | 84 |
| 4 | FAST3 | 640 | 360 | 230.4 | 675 | 338 | 4.03 | 968 | 84 |
| 5 | SD | 896 | 504 | 451.6 | 1323 | 662 | 7.90 | 1897 | 84 |
| 6 | HD | 1280 | 720 | 921.6 | 2700 | 1350 | 16.13 | 3871 | 84 |
| 7 | FHD | 1920 | 1080 | 2073.6 | 6075 | 3038 | 36.29 | 8709 | 84 |
| 8 | 2K | 2560 | 1440 | 3686.4 | 10800 | 5400 | 64.51 | 15483 | 84 |
| 9 | 4K | 3840 | 2160 | 8294.4 | 24300 | 12150 | 145.15 | 34836 | 84 |

TABLE 3
Streaming Service Level for 16:10 screen frame

| | | | | | raw RGB | YUV 4:2:0 | compressed | bandwidth | |
|---|---|---|---|---|---|---|---|---|---|
| | | width | height | pixels | frame size | frame size | frame size | @30 fps | compression |
| # | name | (pixel) | (pixel) | (k) | (KB) | (KB) | (KB) | (kbps) | ratio |
| 1 | MIN | 128 | 80 | 10.2 | 30 | 15 | 0.18 | 43 | 84 |
| 2 | FAST1 | 256 | 160 | 41.0 | 120 | 60 | 0.72 | 172 | 84 |
| 3 | FAST2 | 384 | 240 | 92.2 | 270 | 135 | 1.61 | 387 | 84 |
| 4 | FAST3 | 640 | 400 | 256.0 | 750 | 375 | 4.48 | 1075 | 84 |
| 5 | SD | 896 | 560 | 501.8 | 1470 | 735 | 8.78 | 2107 | 84 |
| 6 | HD | 1280 | 800 | 1024.0 | 3000 | 1500 | 17.92 | 4301 | 84 |
| 7 | FHD | 1920 | 1200 | 2304.0 | 6750 | 3375 | 40.32 | 9677 | 84 |
| 8 | 2K | 2560 | 1600 | 4096.0 | 12000 | 6000 | 71.68 | 17203 | 84 |
| 9 | 4K | 3840 | 2400 | 9216.0 | 27000 | 13500 | 161.28 | 38707 | 84 |

TABLE 4
Streaming Service Level for 4:3 screen frame

| | | | | | raw RGB | YUV 4:2:0 | compressed | bandwidth | |
|---|---|---|---|---|---|---|---|---|---|
| | | width | height | pixels | frame size | frame size | frame size | @30 fps | compression |
| # | name | (pixel) | (pixel) | (k) | (KB) | (KB) | (KB) | (kbps) | ratio |
| 1 | MIN | 160 | 120 | 19.2 | 56 | 28 | 0.34 | 81 | 84 |
| 2 | FAST1 | 320 | 240 | 76.8 | 225 | 113 | 1.34 | 323 | 84 |
| 3 | FAST2 | 480 | 360 | 172.8 | 506 | 253 | 3.02 | 726 | 84 |
| 4 | FAST3 | 640 | 480 | 307.2 | 900 | 450 | 5.38 | 1290 | 84 |
| 5 | SD | 960 | 720 | 691.2 | 2025 | 1013 | 12.10 | 2903 | 84 |
| 6 | HD | 1280 | 960 | 1228.8 | 3600 | 1800 | 21.50 | 5161 | 84 |
| 7 | FHD | 1920 | 1440 | 2764.8 | 8100 | 4050 | 48.38 | 11612 | 84 |
| 8 | 2K | 2560 | 1920 | 4915.2 | 14400 | 7200 | 86.02 | 20644 | 84 |
| 9 | 4K | 3840 | 2880 | 11059.2 | 32400 | 16200 | 193.54 | 46449 | 84 |

TABLE 5
Streaming Service Level for 13:6 screen frame (iPhone X)

| | | | | | raw RGB | YUV 4:2:0 | compressed | bandwidth | |
|---|---|---|---|---|---|---|---|---|---|
| | | width | height | pixels | frame size | frame size | frame size | @30 fps | compression |
| # | name | (pixel) | (pixel) | (k) | (KB) | (KB) | (KB) | (kbps) | ratio |
| 1 | MIN | 156 | 72 | 11.2 | 33 | 16 | 0.20 | 47 | 84 |
| 2 | FAST1 | 312 | 144 | 44.9 | 132 | 66 | 0.79 | 189 | 84 |
| 3 | FAST2 | 468 | 216 | 101.1 | 296 | 148 | 1.77 | 425 | 84 |
| 4 | FAST3 | 780 | 360 | 280.8 | 823 | 411 | 4.91 | 1179 | 84 |
| 5 | SD | 1092 | 504 | 550.4 | 1612 | 806 | 9.63 | 2312 | 84 |
| 6 | HD | 1560 | 720 | 1123.2 | 3291 | 1645 | 19.66 | 4717 | 84 |
| 7 | FHD | 2340 | 1080 | 2527.2 | 7404 | 3702 | 44.23 | 10614 | 84 |
| 8 | 2K | 3120 | 1440 | 4492.8 | 13163 | 6581 | 78.62 | 18870 | 84 |
| 9 | 4K | 4680 | 2160 | 10108.8 | 29616 | 14808 | 176.90 | 42457 | 84 |

A few explanations regarding the service levels and the tables:
The name of the service level is usually used as the suffix of the ID of the media object of that service level.
Usually the preprocessor on the streamer resize the captured screen frame to the resolution of a service level and then encode the frame with the target bitrate (i.e., the bandwidth column in the table).
The levels are carefully selected such that each level consume roughly half the bandwidth than the next level, except for the first level, which is a quarter of the second level.
The screen width and height is deliberately chosen to be a multiple of 8 pixel to facilitate block based encoder such as H.264, H.265, VP8, VP9, etc.
Both RGB and YUV use 8 bits per channel.
In one implementation, for all service levels, a H.264 codec with baseline profile may be used, 30 frames per second, and one key frame every 30 frames can be enforced.
The compressed frame size is an average number. For most video encoding schemes, key frames will have a bigger size than this number but other frames will be much smaller.
If there are multiple watchers requesting the same media object (i.e., the same screen content with the same service level), the streamer grabs the frame and encode it only once. The encoded frame may be packetized in different ways and sent to different watchers due to the per-session packetization-duplication-retransmission policy.

For iPhone 6, iPhone 6S, iPhone 7, iPhone 8, whose screen resolution is non-standard (1334*750) but the ratio is close to standard 16:9, resolution can be resized to 1280*720 in the preprocessor on the streamer side.

For an iPhone X, whose screen resolution is non-standard (2436*1125) and the ratio is also non-standard (13:6), it can be resized it to 2340*1080 in the preprocessor on the streamer side and use another set of quality level parameters in Table 5.

The receiver detects link congestion both from packet loss rate and RTT and estimate a link capacity using a similar method as TCP throughput modeling. Both the sender and the receiver monitor the host resource usage. If the link capacity is enough for the next service level and the host resource usage is below a threshold level (typically 50% of the CPU, 90% of the memory, and 50% of the hardware codec), the watcher makes the decision to upgrade the current service level to the next level. Since the link capacity estimation and host resource monitoring are made periodically (typically every 30 seconds), if the link capacity drops to a critical level (typically twice of the target bitrate of the current service level), or the host resource usage is above the threshold level, the watcher makes the decision to downgrade the current service level to the previous level.

Once the service upgrade or downgrade decision is made, a new session with the target service level will be set up. If no congestion is detected in the new session (i.e., most frames in the new session are delivered on time), and once a key frame is received in the new stream session, the watcher can switch to render the frames from the new session, and the old session can be torn down.

Packet Scheduling and Traffic Shaping:

Packet scheduling is implemented on the sender side to prioritize packets in stream sessions with low service level. This is designed to improve the smoothness when multiple stream sessions are running at the same time, especially when the watcher is going to switch from a low quality level to a high quality level. At the switching point, two sessions are open and the sender will prioritize packets in the low quality level, such that even if the high quality session cause pressure on the network bandwidth, only the packets in the high quality session will be lost. Also for the codec, frames of low service level are always encoded first for the same reason. The following formula may be used to calculate priority:

priority=(10−service level)*100+(100−min(session id,100))

The rationale is that session with lower service level has higher priority, and if two sessions are in the same service level, the session which is set up early (hence, with a smaller session ID) has higher priority. The calculated priority is an integer from 100 to 999.

Traffic shaping is implemented on the sender side for all sessions to enforce a maximum bandwidth usage. It mainly prevents bursting traffic that causes UDP packet loss on the sender side, especially when there are many sessions connected to the same streamer. In this case, once a new frame is grabbed, it is encoded and sent to multiple watchers, which creates a lot of traffic in a short amount of time (usually within one or a few milliseconds) compared to the frame grabbing period (more than 30 milliseconds).

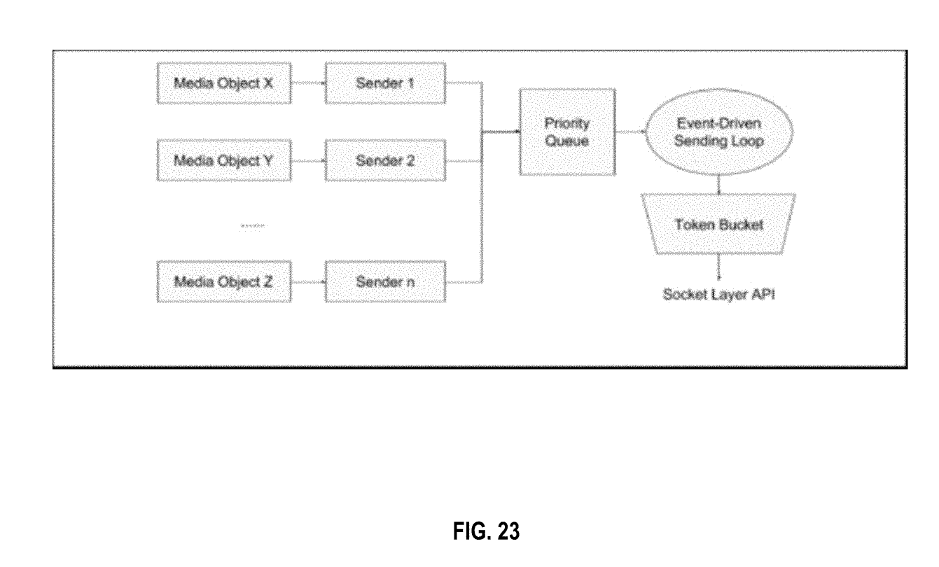

Packet scheduling and traffic shaping are collectively implemented on the streamer, as shown in FIG. 23. Each sender is associated with a media object, which contains the encoded frames. The sender packetize the encoded frames and send the packets to a priority queue, where the priority is associated with each sender (i.e., each session). A event driven sending loop periodically wakes up, retrieves packets from the priority queue, and sends the packets using a token bucket algorithm. In each iteration of the sending loop, tokens are issued to control the amount of outgoing traffic. The amount of token issued for each iteration mainly depends on the outgoing bandwidth and the available memory for transmission buffer inside the kernel, which can be obtained from the network interface and the operating system.

Overrun Control:

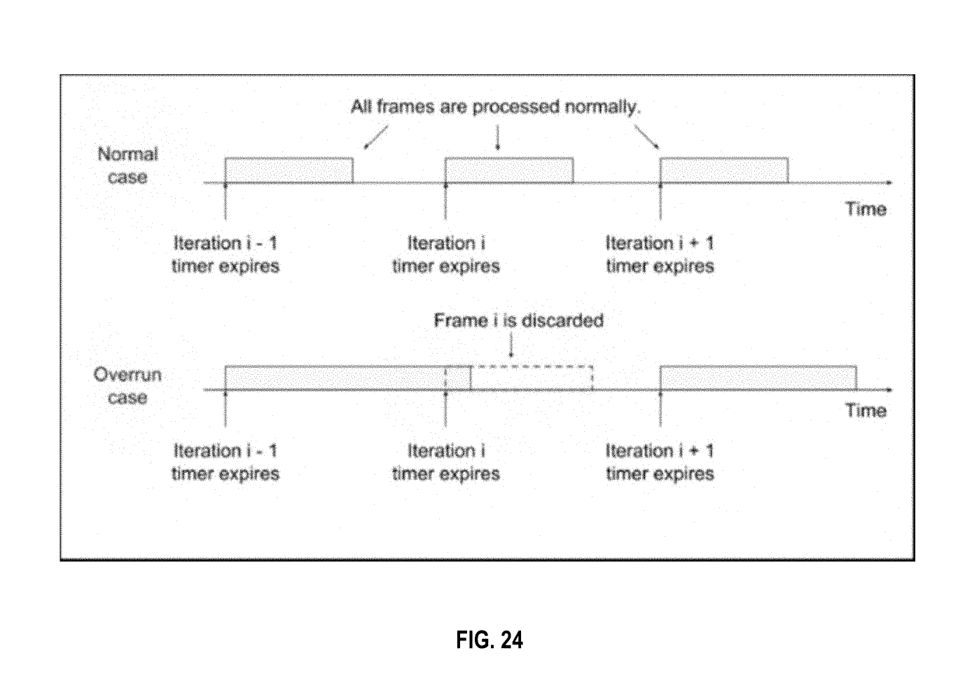

Overrun control means the actions if the current frame is still in process while the next frame arrives. It can happen on the streamer or the watcher due to many reasons such as another process is using a significant portion of the shared CPU resource. Usually when overrun happens, there is no better method but discard the next frame, as illustrated in FIG. 24.

For the streamer, overrun is detected if the streamer timer expires for the next iteration but the current iteration is still not finished. The streamer will take the following action once overrun happens:
1. The streamer skips grabbing the next frame. Hence, the frame rate will be decreased, which influences the smoothness.
2. If overrun happens continuously in K iteration (typically K is 30, the same as default FPS (frame per sec)), the streamer may send a suggestion to downgrade the service level to all stream sessions higher than a certain level (this level is a configurable parameter).
3. If the overrun causes the frame rate to drop below a critical point (typically 1 or 5 FPS) for continuous C frames (typically C is 30), the streamer sends an emergency FEEDFORWARD message to every session and tear down every session. New sessions will not be set up until a manual reset is applied on the streamer.

For the watcher, overrun is detected similarly using the watcher timer. Note that whether the packets are received on time is irrelevant to overrun. It is less likely that a watcher overruns since watcher typically only handles one session. The watcher will take the following action once overrun happens:
1. The watcher skip retrieving and decoding the next frame, even if it arrives on time.
2. If overrun happens continuously in K iteration (typically K is 30, the same as default FPS), the watcher downgrade the service level by one level.
3. If the overrun causes the frame rate to drop below a critical point (typically 1 or 5 FPS) for continuous C frames (typically C is 30), the watcher tear down all sessions and wait for a manual reset.

The rationale behind overrun control is that overrun happens when there are too much work to do or too limited resource to spend within one period of frame processing. If it is caused by the streaming app, the workload can be reduced by skipping frames, in the hope that future frame can still be processed smoothly. However, if sever overrun happens continuous, usually it means some other process is taking a significant portion of system resource for emergent work, and hence, the streaming application 102 can be paused temporarily to wait for the user to resume.

Use Cases

A few use cases to illustrate how the system 100 or system 100A may be implemented for collaborative content creation and sharing will be discussed in greater detail.

The present inventive concept is designed to be more than just an individual mobile application. It defines a novel platform to provide private local content creation and sharing in a decentralized or fog network. The described systems 100A-100B emphasize that real time collaborative content creation is more advanced than screen sharing. It enriches the users with exciting user experience. Further, all these can take place without external Internet connectivity. The nature of the design as a platform allows for a variety of new use cases.

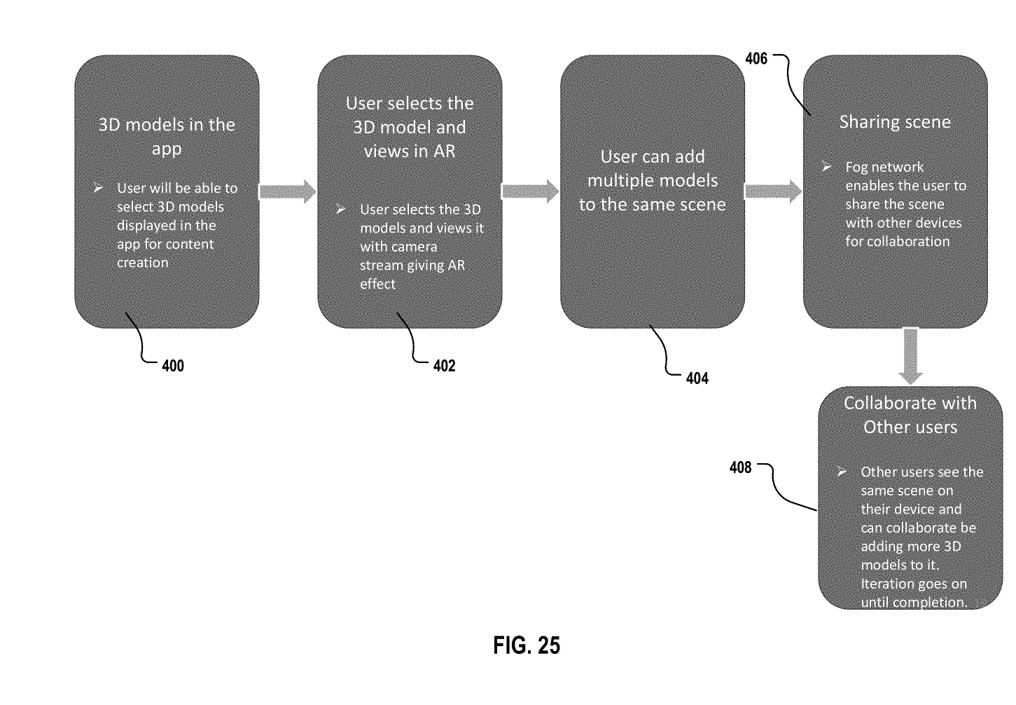

Consider an augmented reality (AR) application that APPLE used to demonstrate its ARKit SDK where a child is able to build and view virtual lego sets in the real world. This design would enable collaboration among children as they collaborate to build something together. This concept can be expanded all the way up to a professional level, with mechanical engineers viewing and analyzing CAD designs in real-time via augmented reality. This kind of collaborative content creation can take place anywhere without the need of internet connectivity as everything will take place in a fog network. The workflow is demonstrated in FIG. 25. At block 400, the user selects a three-dimensional model displayed for content creation. At block 402, the user selects the three-dimensional model and views it with a camera stream giving AR effect. At block 404, the user can add multiple three-dimensional models to the same scene. At block 406, Sharing scene: Fog network enables the user to share the scene with other devices for collaboration. At block 408, collaborate with other users who view the same scene on their device and can collaborate be adding more 3D models to it. Iterations may continue until completion.

Another application use case may relate to off-site meetings and gathering. Sharing and Collaborating on reports, presentations, and legal documents can be an inconvenient process when a group of associates are together in a restaurant or a hotel conference room. The service platform enables users to easily share and collaborate on documents privately even when there is no network connection from their device. Specifically, the CastEx service platform provides the users with tools for content creation. A basic example will be presenting a whiteboard in the service platform with few handy tools to draw or write something. The user can create content this way and also share it in real-time with others.

An example application of this design is for use in medical offices. It is not uncommon for a medical professional to share diagnosis and treatment information with the patient at the time of the visit. Descriptions of each of these data may or may not be given to the patient upon completion of the visit, either on paper or distributed digitally. Having this information is critical to making sure that medical advice is followed exactly as prescribed, and sharing it with family members or other medical professionals may allow for more precise treatment. Furthermore, the majority of medical offices today use digital media to create and describe this information. To improve communication between medical professionals and patients, adding the design proposed here to the existing systems used would enable the real-time informational content to be shared with the patient during the appointment, with the option of saving the stream and the audio from the doctor-patient conversation to the patient's mobile device for later review, allowing the patient to revisit the appointment exactly as it occurred.

The inventive concepts discussed herein provide various improvements to existing device-to-device communications. For example, while some mobile devices are configured with Walkie-talkie like features or functionality, the application 102 described herein could configure such devices to include video streaming in addition to audio streaming. Any device, configured by the application 102 (e.g., having the application 102 installed or having access to its functionality), can share media content with other devices similarly configured.

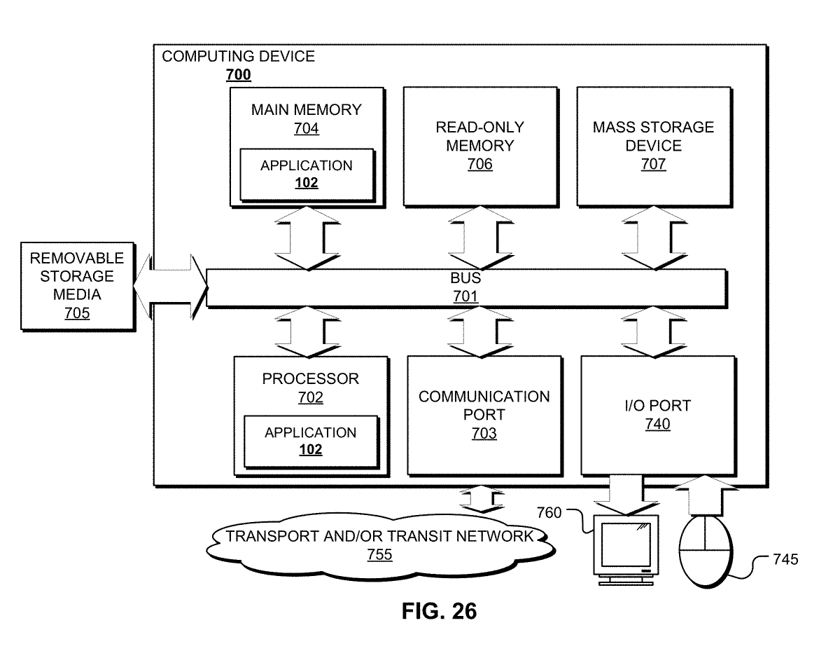

FIG. 26 is an example schematic diagram of a computing device 700 that may implement various methodologies discussed herein. For example, the computing device 700 may comprise any of the devices 101 of the network 108 executing or accessing functionality and/or aspects of the application 102. The computing device 700 includes a bus 701 (i.e., interconnect), at least one processor 702 or other computing element, at least one communication port 703, a main memory 704, a removable storage media 705, a read-only memory 706, and a mass storage device 707. Processor(s) 702 can be any known processor, such as, but not limited to, an Intel® Itanium® or Itanium 2® processor(s), AMD® Opteron® or Athlon MP® processor(s), or Motorola® lines of processors. Communication port 703 can be any of an RS-232 port for use with a modem based dial-up connection, a 10/100 Ethernet port, a Gigabit port using copper or fiber, or a USB port. Communication port(s) 703 may be chosen depending on a network such as a Local Area Network (LAN), a Wide Area Network (WAN), or any network to which the computer device 700 connects. Computing device may further include a transport and/or transit network 755, a display screen 760, an I/O port 740, and an input device 745 such as a mouse or keyboard.

Main memory 704 can be Random Access Memory (RAM) or any other dynamic storage device(s) commonly known in the art. Read-only memory 706 can be any static storage device(s) such as Programmable Read-Only Memory (PROM) chips for storing static information such as instructions for processor 702. Mass storage device 707 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 701 communicatively couples processor(s) 702 with the other memory, storage, and communications blocks. Bus 701 can be a PCI/PCI-X, SCSI, or Universal Serial Bus (USB) based system bus (or other) depending on the storage devices used. Removable storage media 705 can be any kind of external hard drives, thumb drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 704 may be encoded with the application 102 that supports functionality discussed above. In other words, aspects of the application 102 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 702 accesses main memory 704 via the use of bus 701 in order to launch, run, execute, interpret, or otherwise perform processes, such as through logic instructions, executing on the processor 702 and based on the application 102 stored in main memory or otherwise tangibly stored.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

Certain embodiments are described herein as including one or more modules, services, and the like. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” or “module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for real-time screen recording and content sharing between devices, comprising:
forming a network with a plurality of devices, the network being decentralized and managed by the devices;
recording media content associated with a streaming device of the plurality of devices;
generating a stream session between the streaming device and a receiving device of the plurality of devices; and
streaming the media content to the receiving device of the plurality of devices over the network using the stream session,
wherein the stream session utilizes a streaming protocol for adaptive streaming that implements closed-loop control between the streaming device and the receiving device, the closed loop control defining messages about packet transmission communicated between the streaming device and the receiving device in real time which are leveraged for streaming decisions.

2. The method of claim 1, wherein the network comprises a fog network where each of the plurality of devices is associated with end-user clients and the network is end-user client driven such that and each of the plurality of devices is configured to manage communication with other devices of the network such that the network is devoid of a separate managing network device.

3. The method of claim 1, further comprising:
forming the network using a host device of the plurality of devices, by:
generating an authentication code for one or more client devices of the plurality of devices,
confirming receipt of the authentication code from the one or more client devices.

4. The method of claim 1, further comprising recording the media content using in-app recording including accessing one or more APIs associated with an operating system of the streaming device.

5. The method of claim 1, further comprising recording the media content using full screen recording by activating a background service configured for recording a full screen broadcast, the background service associated with an operating system of the streaming device.

6. The method of claim 1, further comprising:
recording the media content by capturing a plurality of raw screen frames of the streaming device; and
applying an encoder associated with the streaming device to encode the plurality of raw screen frames and generate a plurality of encoded screen frames in real time.

7. The method of claim 6, wherein the streaming device and the receiving device are implementing different operating systems yet are still in operable communication with one another via the decentralized network and configured to share video or audio content with one another.

8. The method of claim 6, further comprising:
reducing a processing rate of the encoder to a value lower than a capturing date to accommodate real time encoding without stackup of the plurality of raw screen frames during encoding.

9. The method of claim 6, further comprising:
receiving, at the streaming device, a plurality of session parameters associated with the receiving device; and
upon generating the stream session, tuning parameters of the encoder according to the plurality of session parameters.

10. The method of claim 1, wherein forming the network includes creating, by the streaming device, a hotspot and connecting the receiving device to the hotspot via a Wi-Fi connection.

11. An apparatus, comprising:
a device, the device configured for forming a decentralized network, encoding and packetizing a plurality of frames associated with the device, generating a stream session referencing received session parameters, and broadcasting the plurality of frames via the stream session.

12. The apparatus of claim 11, wherein the device is further configured to adaptively update a streaming rate associated with the stream session based on changes to screen content associated with the plurality of frames.

13. The apparatus of claim 11, wherein the device is further configured to actively duplicate a packet associated with a frame of the plurality of frames and broadcast the frame via the stream session at least twice to reduce packet loss.

14. The apparatus of claim 11, wherein the device is configured to reference information defined by a FEEDBACK message and a FEEDFORWARD message associated with the stream session to detect congestion of the decentralized network, estimate link capacity and modify the stream session, the FEEDFORWARD message defining statistical information about packet transmission to other devices.

15. The apparatus of claim 11, wherein the device is further configured with overrun control by skipping a next frame associated with the plurality of frames during the stream session to reduce a frame rate.

16. The apparatus of claim 11, wherein the device is further configured to customize packet sizes associated with the plurality of frames based on predetermined priority associated with predetermined ones of the plurality of frames.

17. The apparatus of claim 11, further comprising a receiving device in operable communication with the device via the decentralized network and configured to access the plurality of frames via the stream session, wherein the receiving device is further configured with dynamically changing buffering time parameters based on predetermined network quality conditions.

18. A non-transitory tangible media comprising logic for execution by a machine and when executed by the machine operable for:
forming a decentralized network;
accessing a frame defining media content;
applying the frame to a hardware encoder to output an encoded frame; and
broadcasting the encoded frame via a stream session.

19. The non-transitory tangible media of claim 18, further comprising logic for execution by a machine and when executed by the machine operable for:
encoding the frame using a predetermined target bitrate according to a predetermined service level associated with a receiving device.

20. The non-transitory tangible media of claim 18, further comprising logic for execution by a machine and when executed by the machine operable for:
initiating a first stream session using session parameters defining a predetermined default quality; and
initiating a second stream session using other session parameters defining a different predetermined quality to accommodate changes to the decentralized network.
